(19) United States
(12) Patent Application Publication
(10) Pub. No.: US 2026/0161251 A1
(43) Pub. Date: Jun. 11, 2026

(54) DETECTION DEVICE AND OPERATION UNIT

(71) Applicant: Alps Alpine Co., Ltd., Tokyo (JP)

(72) Inventor: Kazuhito OSHITA, Miyagi-ken (JP)

(21) Appl. No.: 19/411,754

(22) Filed: Dec. 8, 2025

(30) Foreign Application Priority Data
Dec. 9, 2024 (JP) 2024-214620

(51) Int. Cl. G06F 3/041; G06F 3/044

(52) U.S. Cl. CPC G06F 3/0418; G06F 3/044

(57) ABSTRACT

A detection device includes an electrostatic sensor disposed on a holding member having a conductor to which a predetermined potential or a potential of a predetermined waveform is applied, a detection circuit connected to the electrostatic sensor and configured to detect a capacitance of the electrostatic sensor, a misalignment calculation unit configured to calculate a misalignment of the electrostatic sensor relative to the conductor or a value corresponding to the misalignment, based on an output of the detection circuit in a target object non-proximity state, a correction value calculation unit configured to calculate a correction value corresponding to the misalignment calculated by the misalignment calculation unit or to the value corresponding to the misalignment, and a detection unit configured to detect a position of a target object based on the output of the detection circuit and the correction value calculated by the correction value calculation unit.

### CLAIM OF PRIORITY

This application claims benefit of Japanese Patent Application No. 2024-214620 filed on Dec. 9, 2024, which is hereby incorporated by reference.

### BACKGROUND OF THE INVENTION

### 1. Field of the Invention

The present disclosure relates to a detection device and an operation unit.

### 2. Description of the Related Art

A known input device includes a plurality of conductive operation knobs, a plurality of electrodes each provided as pairs with the plurality of operation knobs and are disposed to face the corresponding operation knobs respectively among the plurality of operation knobs at a predetermined distance, a detection means for detecting the capacitance generated between the operation knobs and the electrodes, and an operation determination means for determining an operation performed on the plurality of operation knobs based on the capacitance detected by the detection means (for example, see Japanese Unexamined Patent Application Publication No. 2014-110194).

However, if the mounting positions of the plurality of electrodes relative to the corresponding operation knobs vary, operations performed on the plurality of operation knobs may not be detected accurately.

Accordingly, a detection device and an operation unit capable of accurately detecting a position of a target object are provided.

### SUMMARY OF THE INVENTION

A detection device according to an aspect of the disclosure includes an electrostatic sensor disposed on a holding member having a conductor to which a predetermined potential or a potential of a predetermined waveform is applied, a detection circuit connected to the electrostatic sensor and configured to detect a capacitance of the electrostatic sensor, a misalignment calculation unit configured to calculate a misalignment of the electrostatic sensor relative to the conductor or a value corresponding to the misalignment, based on an output of the detection circuit in a non-proximity state in which a target object is not in close proximity to the conductor, a correction value calculation unit configured to calculate a correction value corresponding to the misalignment calculated by the misalignment calculation unit or to the value corresponding to the misalignment, and a detection unit configured to detect a position of a target object based on the output of the detection circuit and the correction value calculated by the correction value calculation unit.

### BRIEF DESCRIPTION OF THE DRAWINGS

FIG. 1 is an external view of an operation unit 200 including a detection device 100 according to an embodiment;

FIG. 2 is a cross-sectional view taken along a plane parallel to an XZ plane of the operation unit 200;

FIG. 3 is an external view of a sensor unit 150;

FIG. 4 is a diagram illustrating an example of the sensor unit 150 disposed on a metal member 11;

FIG. 5 is a diagram illustrating an example structure of a sensor sheet 115;

FIG. 6A is a diagram illustrating an example of eight electrostatic sensors 110 disposed without misalignment relative to the metal member 11;

FIG. 6B is a diagram illustrating an example of misalignment of the eight electrostatic sensors 110 relative to the metal member 11;

FIG. 6C is a diagram illustrating an example of misalignment of the eight electrostatic sensors 110 relative to the metal member 11;

FIG. 6D is a diagram illustrating an example of misalignment of the eight electrostatic sensors 110 relative to the metal member 11;

FIG. 7A is a diagram illustrating an example of the eight electrostatic sensors 110 disposed without misalignment relative to the metal member 11;

FIG. 7B is a diagram illustrating an example of misalignment of the eight electrostatic sensors 110 relative to the metal member 11;

FIG. 7C is a diagram illustrating an example of misalignment of the eight electrostatic sensors 110 relative to the metal member 11;

FIG. 7D is a diagram illustrating an example of misalignment of the eight electrostatic sensors 110 relative to the metal member 11;

FIG. 8A is a flowchart illustrating an example of processing to be performed by a misalignment calculation unit 131; and

FIG. 8B is a flowchart illustrating an example of processing to be performed by the misalignment calculation unit 131.

### DESCRIPTION OF THE PREFERRED EMBODIMENTS

Hereinafter, a detection device and an operation unit according to an embodiment of the disclosure will be described.

In the following description, an XYZ coordinate system is defined and described. A direction (X direction) parallel to the X axis, a direction (Y direction) parallel to the Y axis, and a direction (Z direction) parallel to the Z axis are mutually orthogonal to each other. A phrase “in plan view” refers to viewing an XY plane. For the sake of convenience, the +Z direction side denotes the upper side, and the −Z direction side denotes the lower side. However, this does not represent a universal vertical relationship. In the description below, for easy understanding of the structure, the length, width, thickness, and the like of each component may be exaggerated.

### Operation Unit 200 Including Detection Device 100 According to Embodiment

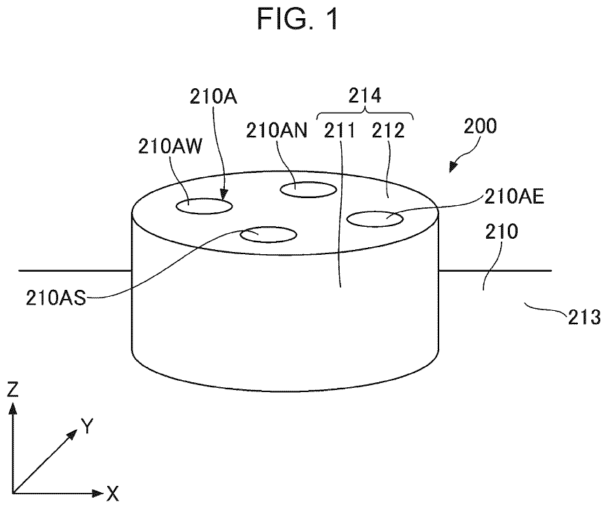

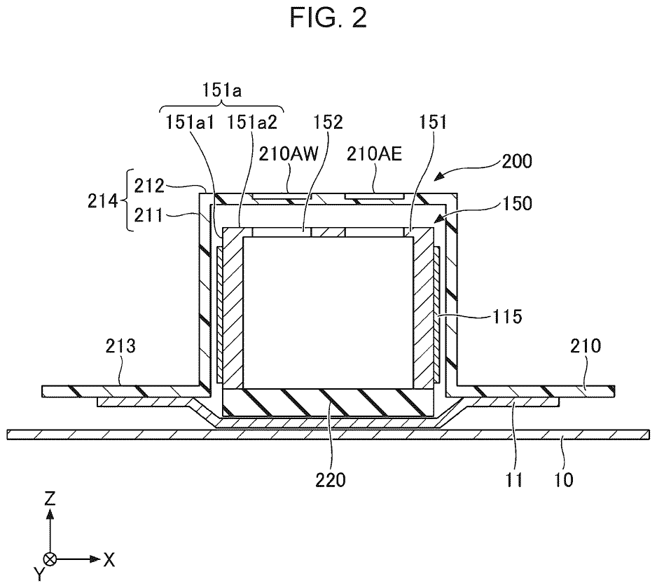

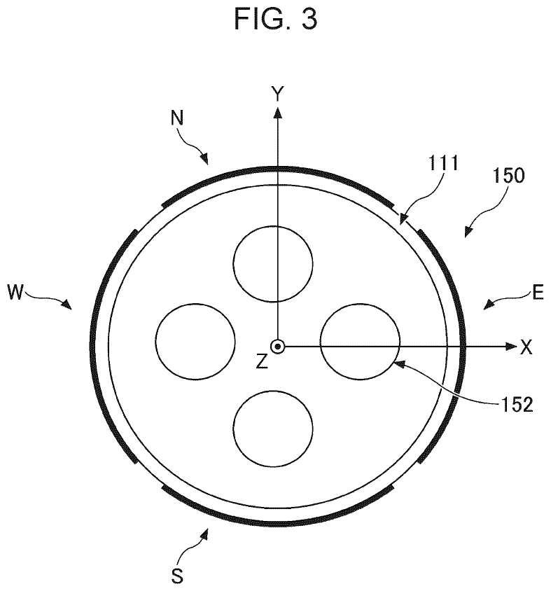

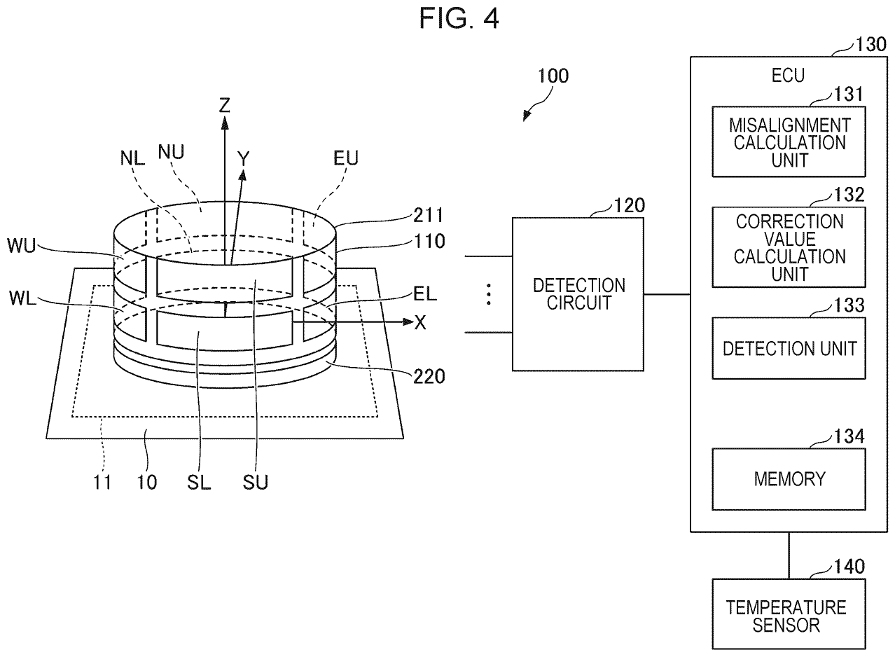

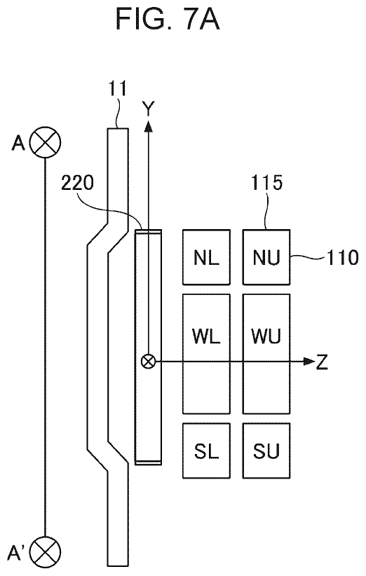

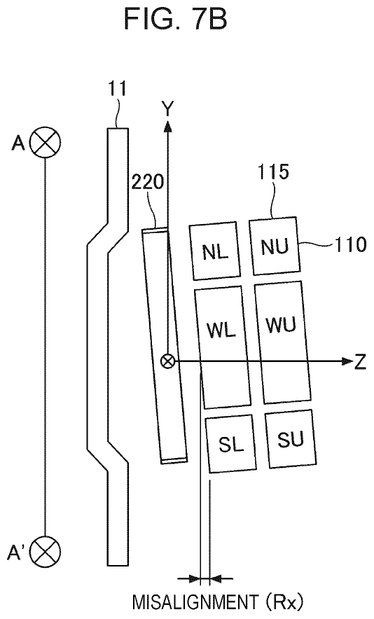

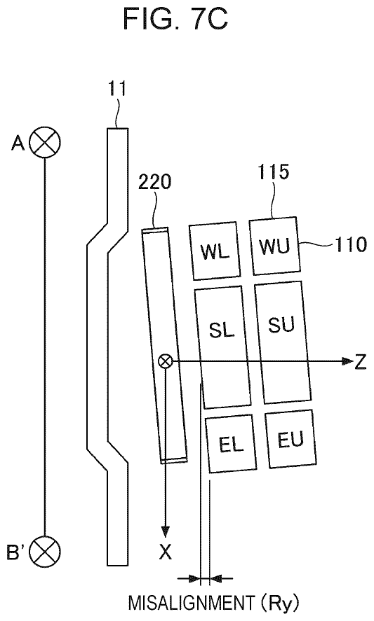

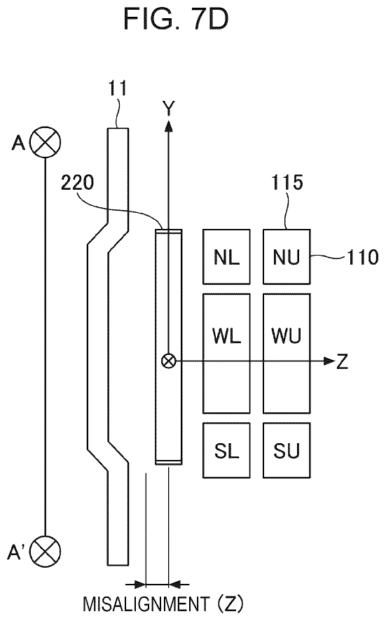

FIG. 1 is a perspective view illustrating a structure of the operation unit 200 that includes the detection device 100 according to the embodiment. FIG. 2 is a cross-sectional view taken along a plane parallel to the XZ plane of the operation unit 200. FIG. 3 is an external view of the sensor unit 150 provided with the detection device 100. FIG. 4 is a diagram illustrating the sensor unit 150 disposed on the metal member 11. The XYZ coordinates are set with respect to the metal member 11. The positional relationship between the sensor unit 150 that is mounted on the metal member 11 without misalignment, the metal member 11, and an operation panel 210 is fixed. Accordingly, the XYZ coordinates are set with respect to the operation panel 210, or with respect to the sensor unit 150 that is mounted on the metal member 11 without misalignment. The origin of the XY-plane coordinates is located at the center of a protruding portion 214 in plan view, coincides with the center (see FIG. 3) of the sensor unit 150 that is mounted on the metal member 11 without misalignment in plan view, and can be expressed interchangeably. The origin of Z-axis coordinates is located at the Z-direction center of a base 220 of the sensor unit 150 that is mounted on the metal member 11 without misalignment, as one example (see FIG. 7A).

### Structure of Operation Unit 200

The operation unit 200 includes the sensor unit 150, which is provided with the detection device 100, and the operation panel 210 (see FIG. 1). The operation panel 210 has a flat portion 213 and the cylindrical protruding portion 214 that is to be operated by the operator. The operation panel 210 is mounted on a conductive metal base plate 10. The base plate 10 includes, for example, the plate-shaped metal member 11. The base plate 10 is an example of a holding member that holds the metal member 11. The metal member 11 is an example conductor. The base plate 10 is, for example, a part of a vehicle chassis. The metal member 11 is mounted on the base plate 10 by welding or the like, or is a part of the base plate 10. The base plate 10 and the metal member 11 are covered by the operation panel 210 and are not exposed. The base plate 10 is grounded and the metal member 11 is also grounded. A predetermined potential or a potential of a predetermined waveform may be applied to the base plate 10 and the metal member 11 from an electronic device (not illustrated) of the vehicle. The metal member 11 and the operation panel 210 are mounted on the base plate 10 in a precisely positioned state.

The operation panel 210 is, for example, a vehicle front panel integrally formed with the protruding portion 214 that is actually operated by the operator. The operation panel 210 includes the protruding portion 214 and the flat portion 213 surrounding the protruding portion 214, and the protruding portion 214 has a side surface 211 and a top surface 212 as illustrated in FIG. 1. The protruding portion 214 is a cup-shaped member that has a cylindrical wall portion (side wall) having the side surface 211 and a disc-shaped wall portion having the circular top surface 212. The operation panel 210 is made of, for example, resin. Note that the protruding portion 214 may be formed integrally with the flat portion 213, or may be formed separately and then integrally formed by holding one of the portions to the other portion.

The protruding portion 214 of the operation panel 210 includes, for example, four operation portions 210A. For example, the four operation portions 210A are provided at 90-degree intervals on a circumference centered at the center of the top surface 212. Around the center of the top surface 212, one operation portion 210AW is provided on the −X direction side, one operation portion 210AE is provided on the +X direction side, one operation portion 210AS is provided on the −Y direction side, and one operation portion 210AN is provided on the +Y direction side. As one example, the operation portions 210A display symbols (marks, signs, characters, numbers, or the like) representing the functions of electrical components of the vehicle. Such symbols may be printed, or may be illuminated by light-emitting diodes (LEDs) or similar devices that are provided in the operation unit 200, specifically in the base 220 inside the sensor unit 150, such that the light may be transmitted through the symbols.

### Structure of Sensor Unit 150

The sensor unit 150 includes the detection device 100 and a holder 151 that holds the detection device 100. The holder 151 includes a first case 151a that has openings on one side, and the base 220 that is mounted on a lower opening of the first case 151a. The first case 151a has a side surface 151a1 and a top surface 151a 2. The first case 151a is a cup-shaped member that has a cylindrical wall portion (side wall) having the side surface 151a1 and a disc-shaped wall portion (top wall) having the circular top surface 151a2. The sensor sheet 115 of the detection device 100 is mounted on the side surface 151a1, and through holes that correspond to the operation portions 210A are provided in the top surface 151a2, forming transmission portions 152.

The base 220 (see FIG. 2) is a substrate made of an insulating resin and on which a detection circuit 120 (not illustrated in FIG. 2), an electronic control unit (ECU) 130 (not illustrated in FIG. 2), a temperature sensor 140 (not illustrated in FIG. 2), the aforementioned LEDs and other components (not illustrated in FIG. 2) of the detection device 100 are mounted. In this embodiment, the sensor unit 150 is mounted on the metal member 11 of the base plate 10 of the vehicle via the base 220 by using a double-sided tape, adhesive, or the like. The sensor unit 150 may be mounted on the metal member 11 of the base plate 10 via the first case 151a.

### Structure of Detection Device 100

The detection device 100 includes the electrostatic sensor 110, the detection circuit 120, and the ECU 130, and in this embodiment, includes the temperature sensor 140. FIG. 4 illustrates the detection circuit 120, the ECU 130, and the temperature sensor 140 in simplified form. The detection circuit 120, the ECU 130, and the temperature sensor 140 are provided in the sensor unit 150 in this embodiment, but may be provided outside the sensor unit 150. Alternatively, the detection circuit 120 may be provided in the sensor unit 150, and the ECU 130 and the temperature sensor 140 may be provided outside the sensor unit 150. Alternatively, the detection circuit 120 and the ECU 130 may be provided in the sensor unit 150, and the temperature sensor 140 may be provided outside the sensor unit 150.

### Electrostatic Sensor 110

The electrostatic sensor 110 is provided on an outer surface of the cylindrical wall portion having the side surface 151a1, as illustrated in FIG. 2 and FIG. 4. The electrostatic sensor 110 may be provided on an inner surface of the cylindrical wall portion having the side surface 151a1 (rear surface of the side surface 151a1 of the cylindrical wall portion). As an example, the electrostatic sensor 110 (can also be referred to as an electrode of the electrostatic sensor) comprises eight electrostatic sensors. As an example, each of the electrostatic sensors 110 is made of a metal foil of copper, aluminum, or the like. Each electrostatic sensor 110 has a shape of a rectangular metal foil curved along the side surface 151a1 as one example, but it is not limited to such a rectangular shape and may be trapezoidal, elliptical, or other shapes. Each electrostatic sensor 110 is connected to the detection circuit 120.

The eight electrostatic sensors 110 are disposed, for example, in two tiers (upper tier, lower tier) in the vertical direction. In each tier, four electrostatic sensors 110 are disposed in the circumferential direction of the side surface 151a1. In each tier, the four electrostatic sensors 110 disposed in the circumferential direction have equal lengths in the circumferential direction and have equal widths in the vertical direction. That is, the four electrostatic sensors 110 disposed in the circumferential direction have equal areas and shapes. In addition, the four electrostatic sensors 110 disposed in the circumferential direction are equally spaced in the circumferential direction.

In each tier, the centers of the lengths in the circumferential direction of two electrostatic sensors 110 of the four electrostatic sensors 110 disposed in the circumferential direction are located along the X-axis, as an example, whereas the centers of the lengths in the circumferential direction of the remaining two electrostatic sensors 110 are located along the Y-axis, as an example. Accordingly, the two electrostatic sensors 110 disposed in the upper and lower tiers at the four positions in the circumferential direction have equal areas and shapes and the circumferential positions of the electrostatic sensors 110 in the circumferential direction coincide.

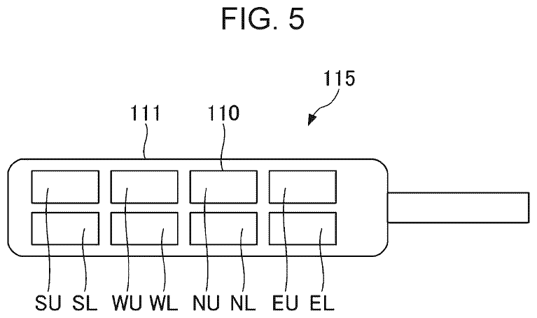

Such electrostatic sensors 110 disposed along the side surface 151a1 may be fabricated, as in FIG. 5 as an example, by attaching a flexible substrate 111 with the eight electrostatic sensors 110 formed thereon to the side surface 151a1 of the sensor unit 150. FIG. 5 is a diagram illustrating an example of the structure of the sensor sheet 115. The sensor sheet 115 is implemented by the flexible substrate 111, and the eight electrostatic sensors 110 are formed on one surface of the flexible substrate 111. The flexible substrate 111 has, as an example, an elongated rectangular shape. On one surface of a flexible insulating substrate, the eight electrostatic sensors 110, each having the same area and the same shape, are formed in two rows (vertical) and four columns (horizontal) at equal intervals in both vertical and horizontal directions. Note that wiring patterns and terminal electrodes formed on the flexible substrate 111 to connect each electrostatic sensor 110 to the detecting circuit 120 are omitted in FIG. 4 and FIG. 5.

In the description below, when the eight electrostatic sensors 110 are distinguished, the electrostatic sensors 110 are denoted to as follows: The −X direction side is denoted as W (West), the +X direction side as E (East), the −Y direction side as S (South), the +Y direction side as N (North), the upper tier as U (Upper), and the lower tier as L (Lower). Under this rule, as illustrated in FIG. 4, the electrostatic sensor 110 in the lower tier on the −X direction side is referred to as WL, and the electrostatic sensor 110 in the upper tier on the −X direction side is referred to as WU. The electrostatic sensor 110 in the lower tier on the +X direction side is referred to as EL, and the electrostatic sensor 110 in the upper tier on the +X direction side is referred to as EU. The electrostatic sensor 110 in the lower tier on the −Y direction side is referred to as SL, and the electrostatic sensor 110 in the upper tier on the −Y direction side is referred to as SU. The electrostatic sensor 110 in the lower tier on the +Y direction side is referred to as NL, and the electrostatic sensor 110 in the upper tier on the +Y direction side is referred to as NU. Note that FIG. 5 illustrates the eight electrostatic sensors 110 on the sensor sheet 115, labeled SL, SU, WL, WU, NL, NU, EL, and EU, in a state in which the sensor sheet 115 is not yet attached to the side surface 151a1 of the sensor unit 150.

### Detection Circuit 120

The detection circuit 120 is connected to each electrostatic sensor 110 and detects the capacitance of each electrostatic sensor 110. The detection circuit 120 digitally converts the capacitance of each electrostatic sensor 110 to obtain a value AD that corresponds to the capacitance of each electrostatic sensor 110, and outputs the value to the ECU 130.

### ECU 130

The ECU 130 includes the misalignment calculation unit 131, a correction value calculation unit 132, a detection unit 133, and memory 134. The ECU 130 is connected to the detection circuit 120.

The ECU 130 is implemented by a computer including a central processing unit (CPU), random access memory (RAM), read only memory (ROM), input-output interfaces, internal buses, and the like. The misalignment calculation unit 131, the correction value calculation unit 132, and the detection unit 133 represent the functions of programs performed by the ECU 130 as function blocks. The memory 134 functionally represents memory of the ECU 130.

### Misalignment Calculation Unit 131

The misalignment calculation unit 131 calculates a misalignment of the electrostatic sensor 110 relative to the metal member 11 or a value corresponding to the misalignment, based on an output of the detection circuit 120 in a non-proximity state in which a target object is not in close proximity to the metal member 11. This processing is described in detail below.

### Correction Value Calculation Unit 132

The correction value calculation unit 132 calculates a correction value that corresponds to a misalignment calculated by the misalignment calculation unit 131 or corresponds to a value corresponding to the misalignment. This processing is described in detail below.

### Detection Unit 133

The detection unit 133 detects a position of a target object relative to the metal member 11 based on an output of the detection circuit 120 and a correction value calculated by the correction value calculation unit 132. This processing is described in detail below.

### Temperature Sensor 140

The capacitance of the electrostatic sensor 110 changes with temperature. The temperature sensor 140 is used to correct the capacitance of the electrostatic sensor 110 due to temperature changes, thereby enabling more accurate detection of whether a fingertip or the like is in proximity to or touching the operation portion 210A. The temperature sensor 140 includes a thermistor. When an output value of a base line (a value corresponding to the noise floor and is set assuming no detection target is present in the vicinity) is determined by using a reference electrode provided separately, a change in the baseline of the electrostatic sensor 110 due to temperature change and a change in the capacitance value of the reference electrode can be considered equivalent. Accordingly, by measuring the capacitance value of the reference electrode, the baseline of the electrostatic sensor 110 can be estimated accurately. Accordingly, even if temperature changes occur, a change (difference value ΔAD) in the capacitance of the electrostatic sensor 110 due to proximity of a fingertip or the like can be accurately determined. However, when such a reference electrode is provided for correction, the baseline value may vary due to a misalignment in mounting position of the reference electrode to a vehicle or the like. If the value of the baseline is set based on the temperature measured by the temperature sensor 140, such a misalignment when the reference electrode is provided is less likely to affect the value.

Such an operation unit 200 can be operated by the operator by touching the surface of one of the four operation portions 210A with a finger or the like. The fingertip or the like of the operator is an example target object. The position of the target object is detected based on the capacitance of the electrostatic sensor 110.

Such an operation unit 200 is disposed on the metal member 11, and thus the eight electrostatic sensors 110 are affected by the parasitic capacitance between the electrostatic sensors 110 and the metal member 11.

Such parasitic capacitance between the eight electrostatic sensors 110 and the metal member 11 may vary depending on the positions of the eight electrostatic sensors 110 relative to the metal member 11. In addition, when the sensor unit 150 is attached to the metal member 11, the sensor unit 150 may be misaligned relative to the metal member 11. In other words, as described above, since the metal member 11 and the operation panel 210 are mounted on the base plate 10 in a precisely positioned state, if a misalignment occurs when the sensor unit 150 is attached to the metal member 11, the sensor unit 150 may be misaligned relative to the operation panel 210, which has the four operation portions 210A. In addition, when the sensor sheet 115 (see FIG. 5), on which the eight electrostatic sensors 110 are formed, is attached to the side surface 151a1 of the sensor unit 150, the sensor sheet 115 may be misaligned relative to the sensor unit 150. Since the determination of proximity or touch to the four operation portions 210A is performed based on outputs of the electrostatic sensors 110, if such a misalignment occurs between the electrostatic sensors 110 and the four operation portions 210A, the detection accuracy of the determination of proximity or touch to the four operation portions 210A may decrease.

### Specific Examples of Misalignment

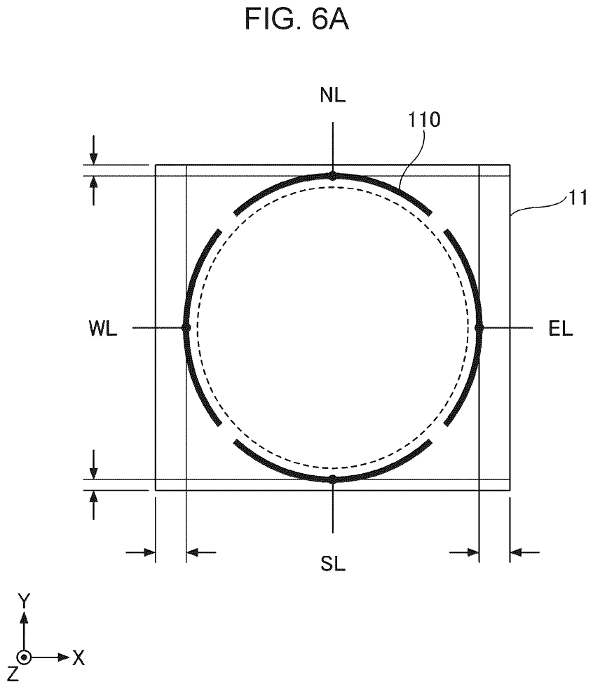

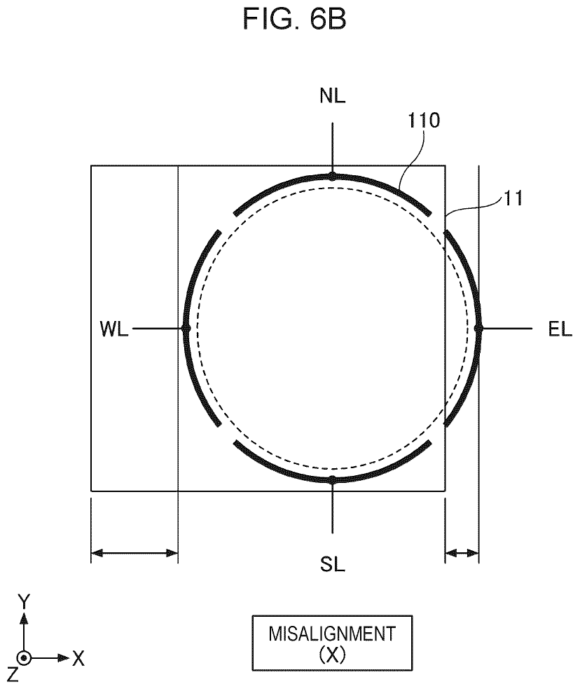

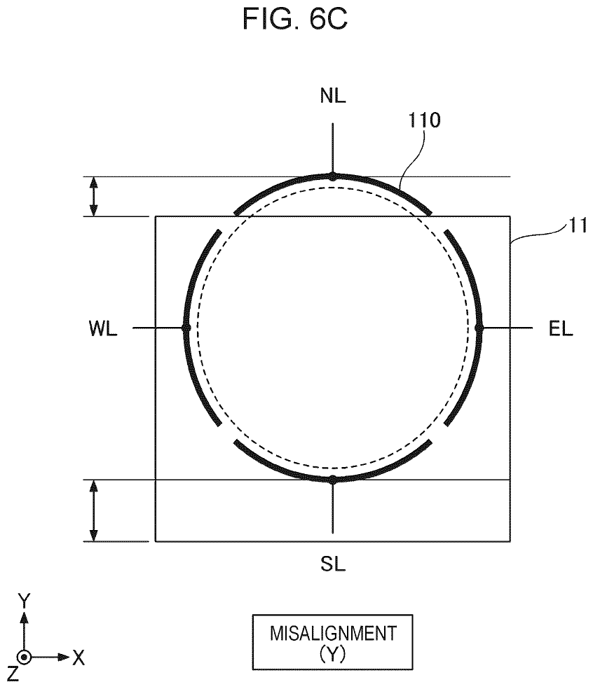

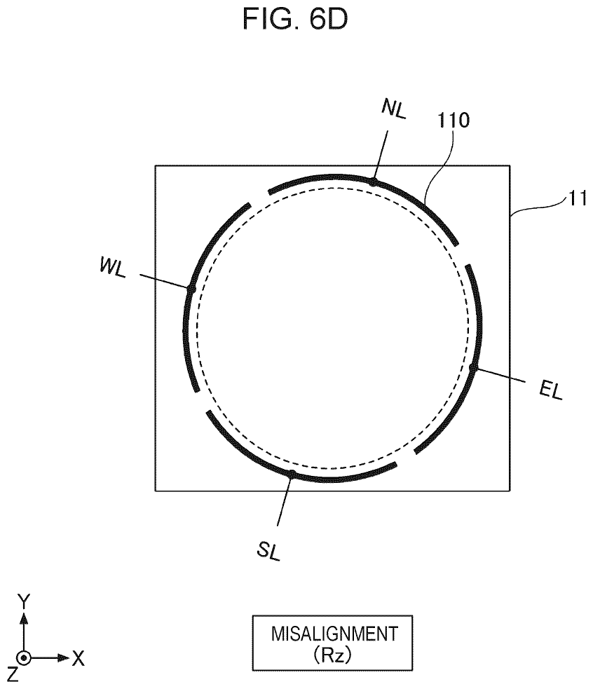

FIG. 6A to FIG. 6D and FIG. 7A to FIG. 7D are diagrams illustrating examples of misalignment of the eight electrostatic sensors 110 relative to the metal member 11 assuming that misalignments occur when the sensor unit 150 is attached to the metal member 11, with virtually no misalignment of the electrostatic sensors 110 relative to the sensor unit 150.

### FIG. 6A to FIG. 6D

FIG. 6A to FIG. 6D are diagrams assuming that misalignment in the horizontal direction occurs when the sensor unit 150 is attached to the metal member 11, and assuming that misalignment in the horizontal direction may occur with virtually no misalignment in the Z direction with the use of a positioning mechanism for the sensor unit 150 and the metal member 11. For example, such a case includes when the base 220 is attached to the metal member 11 without being inclined in the Z direction.

FIG. 6A to FIG. 6D are diagrams illustrating positional relationships between the metal member 11 and the electrostatic sensor 110 in plan view as viewed from the +Z direction. FIG. 6A illustrates a state in which the eight electrostatic sensors 110 are not misaligned relative to the metal member 11. FIG. 6B to FIG. 6D illustrate states in which the eight electrostatic sensors 110 are misaligned relative to the metal member 11 in plan view. In FIG. 6A to FIG. 6D, the eight electrostatic sensors 110 are not inclined relative to the Z axis and the electrostatic sensors 110 in the upper tier and the lower tier overlap, and accordingly, positional relationships between the metal member 11 and the electrostatic sensors 110 (WL, EL, SL, WL) in the lower tier are illustrated. Note that in FIG. 6A to FIG. 6D, the XYZ coordinates are shifted from the eight electrostatic sensors 110.

In FIG. 6A, the eight electrostatic sensors 110 are not misaligned relative to the metal member 11, and thus the eight electrostatic sensors 110 are evenly disposed in the X direction and Y direction relative to the metal member 11. The relationship in size between the metal member 11 and the eight electrostatic sensors 110 in the state with no misalignment is illustrated in FIG. 6A as an example.

In FIG. 6B, the eight electrostatic sensors 110 are misaligned in the +X direction relative to the metal member 11, and the electrostatic sensor EL is beyond the metal member 11 in the +X direction.

In FIG. 6C, the eight electrostatic sensors 110 are misaligned in the +Y direction relative to the metal member 11, and the electrostatic sensor NL is beyond the metal member 11 in the +Y direction.

In FIG. 6D, the eight electrostatic sensors 110 are rotated and misaligned clockwise about the Z-axis relative to the metal member 11. The eight electrostatic sensors 110 are disposed inside the outer edge of the metal member 11 in plan view, but are misaligned relative to the four operation portions 210A (see FIG. 1).

### FIG. 7A to FIG. 7D

FIG. 7A to FIG. 7D illustrate the sensor sheet 115 and the base 220 in addition to the electrostatic sensors 110 and the metal member 11. FIG. 7B to FIG. 7D are diagrams assuming that misalignment in the Z direction occurs when the sensor unit 150 is attached to the metal member 11, and assuming that misalignment in the Z direction occurs with virtually no misalignment in the horizontal direction with the use of a positioning mechanism for the sensor unit 150 and the metal member 11. For example, such a case includes when the center of the metal member 11 and the center of the base 220 are aligned and attached. In FIG. 7B, a guide is provided in the X-axis direction, in FIG. 7C, a guide is provided in the Y-axis direction, and in FIG. 7D, a guide is provided in the Z-axis direction at the center of the holder 151, for example.

FIG. 7A illustrates a state in which neither the sensor unit 150 nor the eight electrostatic sensors 110 are misaligned relative to the metal member 11.

FIG. 7B illustrates a state in which, as viewed from the −X side in the YZ plane, the sensor unit 150 is rotated about the X-axis, and thereby causes a misalignment Rx of the eight electrostatic sensors 110 relative to the metal member 11.

FIG. 7C illustrates a state in which, as viewed from the −Y side in the XZ plane, the sensor unit 150 is rotated about the Y-axis, and thereby causes a misalignment Ry of the eight electrostatic sensors 110 relative to the metal member 11.

FIG. 7D illustrates a state in which, as viewed from the −X side in the YZ plane, the sensor unit 150 is misaligned in the +Z direction, and thereby causes a misalignment Z of the eight electrostatic sensors 110 relative to the metal member 11.

As described with reference to FIG. 6B to FIG. 6D and FIG. 7B to FIG. 7D, for example, if the position of attaching the sensor unit 150 to the base plate 10 is misaligned, as illustrated in FIG. 6B to FIG. 6D, in plan view, the positions of the eight electrostatic sensors 110 may be misaligned relative to the metal member 11.

In addition, for example, if the position of attaching the sensor unit 150 to the base plate 10 is misaligned in the Z direction, as illustrated in FIG. 7B to FIG. 7D, the eight electrostatic sensors 110 may be misaligned relative to the metal member 11 by the misalignment Rx or Ry, or the misalignment Z.

When misalignment occurs between the eight electrostatic sensors 110 and the metal member 11, the parasitic capacitance changes, and therefore the position of a target object may not be accurately detected based on the capacitance of the eight electrostatic sensors 110.

Accordingly, the detection device 100 detects misalignment of the eight electrostatic sensors 110 relative to reference positions and calculates correction values to suppress the effect of misalignment, and then detects a position of a target object based on an output of the detection circuit 120 and the correction value.

The operation unit 200 determines, based on a position of a target object detected by the detection device 100, which one of the four operation portions 210A has received a proximity or touch operation.

### Flowcharts

The following flowcharts show operations to be performed by the misalignment calculation unit 131 for the cases in which the misalignment illustrated in FIG. 6 is assumed and the cases in which the misalignment illustrated in FIG. 7 is assumed, respectively. These operations are performed after a capacitance of each electrostatic sensor 110 is acquired by the detection circuit 120.

The flowcharts to be performed by the misalignment calculation unit 131 are performed after the sensor unit 150 is actually attached to the metal member 11 provided on each vehicle or the like, and are performed in a state in which no detection target object such as a fingertip is present in the vicinity. Specifically, these flowcharts are performed before shipment of vehicles at a factory or each time users operate the devices. As one method of determining whether no detection target object is present in the vicinity when the user operates the device, it is possible to use a condition that the operation unit 200 is not being operated.

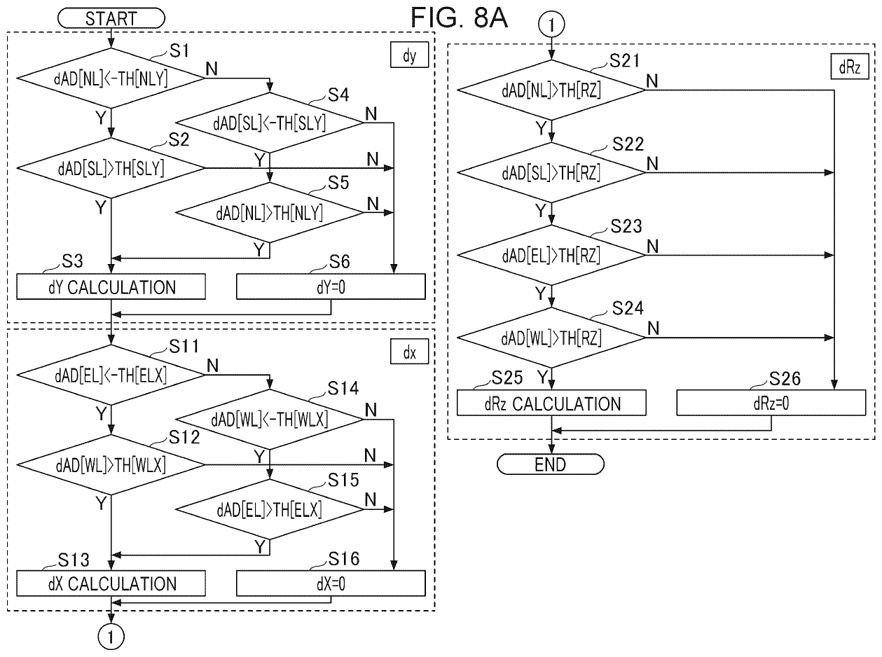

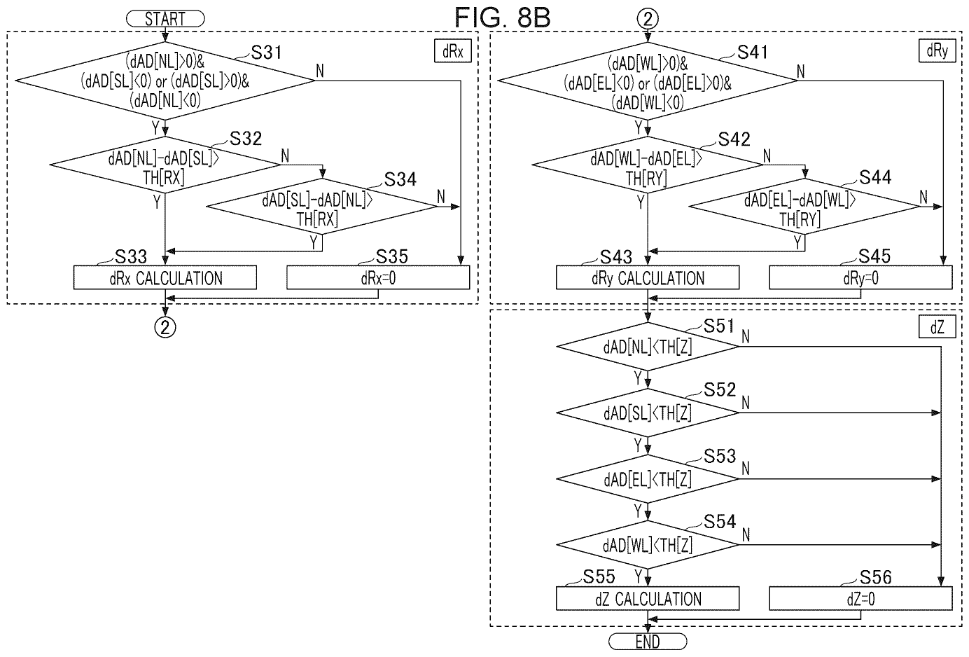

Hereinafter, the flowchart in FIG. 8A is described.

FIG. 8A is a flowchart illustrating an example of processing to be performed by the misalignment calculation unit 131 when any of the misalignments illustrated in FIG. 6 is assumed. Note that when the sensor unit 150 is attached to the metal member 11, and when an attachment mechanism that causes only predetermined misalignment, such as misalignment in the Y direction, is used, it is possible to calculate only misalignment in the Y direction illustrated in steps S1 to S6.

Hereinafter, positions of the eight electrostatic sensors 110 when there is no misalignment are referred to as reference positions. The positions of the electrostatic sensors 110 illustrated in FIG. 6A are the reference positions.

The misalignment calculation unit 131 first calculates misalignments in the Y direction relative to the reference positions of the eight electrostatic sensors 110 through the processing in steps S1 to S6. Next, the misalignment calculation unit 131 calculates misalignments in the X direction relative to the reference positions of the eight electrostatic sensors 110 through the processing in steps S11 to S16. The misalignment calculation unit 131 then calculates misalignments about the Z-axis relative to the reference positions of the eight electrostatic sensors 110 through the processing in steps S21 to S26.

When the misalignment calculation unit 131 calculates misalignments, the misalignment calculation unit 131 uses difference values ΔAD and variation values dAD for the eight electrostatic sensors 110.

A difference value ΔAD is determined by subtracting a baseline (a value set under the assumption that no detection target object is present in the vicinity, corresponding to the noise floor) from a digital value AD of a capacitance.

A variation value dAD is determined by subtracting a difference value ΔAD at a reference position from an actual difference value ΔAD. That is, the variation value dAD represents the amount of fluctuation of the difference value ΔAD caused by a deviation relative to the reference position of each electrostatic sensor 110. Note that an actual difference value ΔAD is a value determined from a digital capacitance value AD detected by the detection circuit 120 after the sensor unit 150 is actually attached to the metal member 11 provided on each vehicle or the like, in a state in which no detection target object is present in the vicinity. After the sensor unit 150 is attached to the metal member 11 beforehand with no misalignment, in a state in which no detection target object is present in the vicinity, difference values ΔAD at the reference positions are obtained beforehand from digital capacitance values AD measured by the detection circuit 120 or are calculated beforehand.

The difference values ΔAD and the variation values dAD are also used below in the same sense in the descriptions of the flowchart in FIG. 8B and other diagrams.

Note that a variation value dAD may be determined by subtracting a digital value AD at a reference position from an actual digital value AD. That is, a variation value dAD may be determined, after the sensor unit 150 is actually attached to the metal member 11 provided on each vehicle or the like, in a state in which no detection target object is present in the vicinity, from an actual digital capacitance value AD detected by the detection circuit 120, by subtracting a digital capacitance value AD at a reference position measured by the detection circuit 120 after the sensor unit 150 is attached to the metal member 11 beforehand with no misalignment, in a state in which no detection target object is present in the vicinity.

Alternatively, a digital value AD may be used instead of a difference value ΔAD.

In the flowchart illustrated in FIG. 8A, as variation values dAD, dAD[NL], dAD[SL], dAD[EL], and dAD[WL] are used.

The variation value dAD[NL] is determined by subtracting a difference value ΔAD[NL] of the electrostatic sensor NL at the reference position from an actual difference value ΔAD[NL] of the electrostatic sensor NL.

The variation value dAD[SL] is determined by subtracting a difference value ΔAD[SL] of the electrostatic sensor SL at the reference position from an actual difference value ΔAD[SL] of the electrostatic sensor SL.

The variation value dAD[EL] is determined by subtracting a difference value ΔAD[EL] of the electrostatic sensor EL at the reference position from an actual difference value ΔAD[EL] of the electrostatic sensor EL.

The variation value dAD[WL] is determined by subtracting a difference value ΔAD[WL] of the electrostatic sensor WL at the reference position from an actual difference value ΔAD[WL] of the electrostatic sensor WL.

Note that the difference value ΔAD[NL] of the electrostatic sensor NL at the reference position, the difference value ΔAD[SL] of the electrostatic sensor SL at the reference position, the difference value ΔAD[EL] of the electrostatic sensor EL at the reference position, and the difference value ΔAD[WL] of the electrostatic sensor WL at the reference position may be acquired beforehand and stored in the memory 134.

In the following flowchart, thresholds TH[NLY], TH[SLY], TH[ELX], TH[WLX], and TH[RZ] are used. The thresholds TH[NLY] and TH[SLY] are used to determine whether variation values dAD[NL] and dAD[SL] indicate misalignments in the Y-direction. The thresholds TH[ELX] and TH[WLX] are used to determine whether variation values dAD[EL] and dAD[WL] indicate misalignments in the X-direction. The thresholds TH[RZ] is used to determine whether variation values dAD[NL], dAD[SL], dAD[EL] and dAD[WL] indicate misalignments in the rotation direction. Appropriate values for the thresholds TH[NLY], TH[SLY], TH[ELX], TH[WLX], and TH[RZ] may also be determined beforehand and stored in the memory 134. Note that the thresholds TH[NLY], TH[SLY], TH[ELX], TH[WLX], and TH[RZ] are set to positive values.

### Steps S1 to S6

In steps S1 to S6, it is determined whether a misalignment in the Y direction has occurred as illustrated in FIG. 6C. In outline steps S1 and S2, it is determined whether there is a misalignment in the +Y direction, and in steps S4 and S5, whether there is a misalignment in the −Y direction. Details are described below.

The misalignment calculation unit 131, in response to the start of the processing (Start), determines whether dAD[NL]<-TH[NLY] (Step S1).

When the misalignment calculation unit 131 determines that dAD[NL]<-TH[NLY] (S1: Yes), it determines whether dAD[SL]>TH[SLY] (Step S2). The meaning of the flowchart of steps S1 to S2 is described below. As illustrated in FIG. 6C, when the sensor unit 150 is misaligned in the +Y direction, the position of the electrostatic sensor NL relative to the metal member 11 becomes closer to the edge of the metal member 11 or outside the metal member 11 compared with that when the electrostatic sensor NL is at the reference position. Accordingly, the area of the metal member 11 that contributes to the capacitance of the electrostatic sensor NL becomes smaller compared with that when the electrostatic sensor NL is at the reference position. As a result, the capacitance between the electrostatic sensor NL and the metal member 11 decreases, causing the difference value ΔAD of the electrostatic sensor NL to also decrease compared with that at the reference position. That is, the variation value dAD[NL] decreases as the misalignment in the +Y direction increases. In step S1, when the difference value of the electrode NL decreases beyond the predetermined value compared with the reference value, it is determined that a misalignment in the +Y direction has occurred (S1: Yes).

As illustrated in FIG. 6C, when the sensor unit 150 is misaligned in the +Y direction, the position of the electrostatic sensor SL relative to the metal member 11 becomes a position closer to the center of the metal member 11 compared with that when the electrostatic sensor SL is at the reference position. Accordingly, the area of the metal member 11 that contributes to the capacitance of the electrostatic sensor SL becomes larger compared with that when the electrostatic sensor SL is at the reference position. As a result, the capacitance between the electrostatic sensor SL and the metal member 11 increases, causing the difference value ΔAD of the electrostatic sensor SL to also increase compared with that at the reference position. That is, the dAD[SL] increases as the misalignment in the +Y direction increases. In step S2, when the difference value of the electrode SL increases beyond the predetermined value compared with the reference value, it is determined that a misalignment in the +Y direction has occurred (S2: Yes).

When the misalignment calculation unit 131 determines that dAD[SL]>TH[SLY] (S2: Yes), it determines that both of the electrostatic sensor NL and the electrostatic sensor SL in the sensor unit 150 have been misaligned in the +Y direction. Accordingly, the misalignment calculation unit 131 determines that an actual misalignment has occurred, and calculates a misalignment dY in the Y direction of the eight electrostatic sensors 110 (step S3). After completing the process of step S3, the misalignment calculation unit 131 advances the flow to step S11.

When the misalignment calculation unit 131 determines that dAD[NL]<-TH[NLY] is not satisfied (S1: No), it determines whether dAD[SL]<-TH[SLY] (Step S4). This process is performed to determine whether the misalignment is a misalignment in the −Y direction.

When the misalignment calculation unit 131 determines that dAD[SL]<-TH[SLY] (Step S4: Yes), it determines whether dAD[NL]>TH[NLY] (Step S5). This process is performed to similarly determine whether the misalignment is a misalignment in the −Y direction.

The meaning of the flowchart of steps S4 to S5 is similar to that of steps S1 to S2 described above; however, since the sensor unit 150 is misaligned in the −Y direction, the increase and decrease of the difference values ΔAD of the electrostatic sensors NL and SL relative to the reference positions are opposite to those when the sensor unit 150 is misaligned in the +Y direction. Accordingly, the difference value ΔAD of the electrostatic sensor SL decreases compared with that at the reference position, and the difference value ΔAD of the electrostatic sensor NL increases compared with that at the reference position. The process of steps S4 to S5 is performed to determine whether the values satisfy such a relationship.

When the misalignment calculation unit 131 determines that dAD[NL]>TH[NLY] (S5: Yes), it determines that, at both of the electrostatic sensor NL and the electrostatic sensor SL, the sensor unit 150 has been misaligned in the −Y direction. Accordingly, the misalignment calculation unit 131 determines that an actual misalignment has occurred, advances the flow to step S3, and calculates a misalignment dY in the Y direction of the eight electrostatic sensors 110 (step S3).

In step S4, when the misalignment calculation unit 131 determines that dAD[SL]<-TH[SLY] is not satisfied (S4: No), it determines that the misalignment dY in the +Y direction and −Y direction of the sensor unit 150, that is, the eight electrostatic sensors 110, is less than or equal to the predetermined value and is 0 (dY=0) (Step S6).

In step S2, when the misalignment calculation unit 131 determines that dAD[SL]>TH[SLY] is not satisfied (S2: No), or in step S5, when it determines that dAD[NL] >TH[NLY] is not satisfied (S5: No), it determines that the misalignment dY in the Y direction of the eight electrostatic sensors 110 is less than or equal to the predetermined value and is negligible, and determines that the misalignment dY is 0 (dY=0) (Step S6). Accordingly, in step S6, dY is determined to be 0 (dY=0).

When it is determined to be No in step S2, it means that, in step S1, it is determined that a misalignment in the +Y direction has occurred and in step S2, it is determined that there is no misalignment in the +Y direction. Accordingly, the determination results are different. Similarly, when it is determined to be No in step S5, it means that, in step S4, it is determined that a misalignment in the −Y direction has occurred and in step S5, it is determined that there is no misalignment in the −Y direction. Accordingly, the determination results are different. When such different determination results are obtained, in this embodiment, it is determined that there is no misalignment. This is because the occurrence of misalignment and its correction are exceptional cases, and if different determination results are obtained, it is unclear whether the misalignment has actually occurred. In such cases, no correction is performed. However, if it is determined that the electrostatic sensor NL or the electrostatic sensor SL is misaligned, correction is performed; alternatively, a misalignment may be determined by considering other factors.

In step S3, the misalignment dY in the Y direction of the eight electrostatic sensors 110 can be calculated, for example, as follows.

The misalignment dY is a misalignment in the −Y direction (S direction) or the +Y direction (N direction). The misalignment calculation unit 131 sets a misalignment dY to the value with the smaller absolute value between dAD[SL] and dAD[NL]. This is because, even if a misalignment occurs, it is considered not to be large, and thus the value with the smaller absolute value is more likely to be correct. In addition, since the occurrence of misalignment and its correction are exceptional cases, this process reduces the impact of correction. Alternatively, the value may be set to a value with a larger absolute value, or may be set to the average of the absolute values.

Note that the misalignment dY is a length, but since the misalignment dY corresponds to the magnitude of dAD[SL] or dAD[NL], dAD[SL] or dAD[NL] is referred to here as the misalignment dY. In this embodiment, the misalignment calculation unit 131 sets dAD[SL] or dAD[NL], each being a value corresponding to a misalignment, as the misalignment dY. However, in practice, the misalignment dY may be calculated from a capacitance value or by using a correspondence table.

### Steps S11 to S16

In steps S11 to S16, it is determined whether a misalignment has occurred in the X direction as illustrated in FIG. 6B. In outline steps S11 and S12, it is determined whether there is a misalignment in the +X direction, and in steps S14 and S15, whether there is a misalignment in the −X direction. The respective steps are similar to steps S1 to S6.

The misalignment calculation unit 131 determines whether dAD[EL]<-TH[ELX] (Step S11).

When the misalignment calculation unit 131 determines that dAD[EL]<-TH[ELX] (Step S11: Yes), it determines whether dAD[WL]>TH[WLX] (Step S12). The meaning of the flowchart of steps S11 to S12 is described below. As illustrated in FIG. 6B, when the sensor unit 150 is misaligned in the +X direction, the position of the electrostatic sensor EL relative to the metal member 11 becomes closer to the edge of the metal member 11 or outside the metal member 11 compared with that when the electrostatic sensor EL is at the reference position. Accordingly, the area of the metal member 11 that contributes to the capacitance of the electrostatic sensor EL becomes smaller compared with that when the electrostatic sensor EL is at the reference position. As a result, the capacitance between the electrostatic sensor EL and the metal member 11 decreases, causing the difference value ΔAD of the electrostatic sensor EL to also decrease compared with that at the reference position. That is, the variation value dAD[EL] decreases as the misalignment in the +X direction increases. In step S11, when the difference value of the electrode EL decreases beyond the predetermined value compared with the reference value, it is determined that a misalignment in the +X direction has occurred (S11: Yes).

As illustrated in FIG. 6B, when the sensor unit 150 is misaligned in the +X direction, the position of the electrostatic sensor WL relative to the metal member 11 becomes closer to the center of the metal member 11 compared with that when the electrostatic sensor WL is at the reference position. Accordingly, the area of the metal member 11 that contributes to the capacitance of the electrostatic sensor WL becomes larger compared with that when the electrostatic sensor WL is at the reference position. As a result, the capacitance between the electrostatic sensor WL and the metal member 11 increases, causing the difference value ΔAD of the electrostatic sensor WL to also increase compared with that at the reference position. That is, the dAD[WL] increases as the misalignment in the +X direction increases. In step S12, when the difference value of the electrode WL increases beyond the predetermined value compared with the reference value, it is determined that a misalignment in the +X direction has occurred (S12: Yes).

When the misalignment calculation unit 131 determines that dAD[WL]>TH[WLX] (S12: Yes), it determines that, at both of the electrostatic sensor EL and the electrostatic sensor WL, the sensor unit 150 has been misaligned in the +X direction. Accordingly, the misalignment calculation unit 131 determines that an actual misalignment has occurred, and calculates a misalignment dX in the X direction of the eight electrostatic sensors 110 (step S13). After completing the process of step S13, the misalignment calculation unit 131 advances the flow to step S21.

In step S11, when the misalignment calculation unit 131 determines that dAD[EL]<-TH[ELX] is not satisfied (S11: No), it determines whether dAD[WL]<-TH[WLX] (Step S14). This process is performed to determine whether the misalignment is a misalignment in the −X direction.

When the misalignment calculation unit 131 determines that dAD[WL]<-TH[WLX] (Step S14: Yes), it determines whether dAD[EL]>TH[ELX] (Step S15). This process is performed to determine whether the misalignment is similarly a misalignment in the −X direction. The meaning of the flowchart of steps S14 to S15 is similar to that of steps S11 to S12 described above; however, since the sensor unit 150 is misaligned in the −X direction, the increase and decrease of the difference values ΔAD of the electrostatic sensors EL and WL relative to the reference positions are opposite. Accordingly, the difference value ΔAD of the electrostatic sensor WL decreases compared with that at the reference position, and the difference value ΔAD of the electrostatic sensor EL increases compared with that at the reference position.

When the misalignment calculation unit 131 determines that dAD[EL]>TH[ELX] (S15: Yes), it determines that, at both of the electrostatic sensor EL and the electrostatic sensor WL, the sensor unit 150 has been misaligned in the −X direction. Accordingly, the misalignment calculation unit 131 determines that an actual misalignment has occurred, advances the flow to step S13, and calculates a misalignment dX in the X direction of the eight electrostatic sensors 110 (step S13).

In step S14, when the misalignment calculation unit 131 determines that dAD[WL]<-TH[WLX] is not satisfied (S14: No), it determines that the misalignment dX in the +X direction and −X direction of the sensor unit 150, that is, the eight electrostatic sensors 110, is less than or equal to the predetermined value and is 0 (dX=0) (Step S16).

In step S12, when the misalignment calculation unit 131 determines that dAD[WL]>TH[WLX] is not satisfied (S12: No), or determines that dAD[EL]>TH[ELX] is not satisfied (S15: No), it determines that the misalignment dX in the X direction of the eight electrostatic sensors 110 is less than or equal to the predetermined value and is negligible, and determines that the misalignment dX is 0 (dX=0) (Step S16). Accordingly, in step S16, dX is determined to be 0 (dX=0).

In step S12, when it is determined to be No, it means that, in step S11, it is determined that a misalignment in the +X direction has occurred and in step S12, it is determined that there is no misalignment in the +X direction. Accordingly, the determination results are different. Similarly, when it is determined to be No in step S15, it means that, in step S14, it is determined that a misalignment in the −X direction has occurred and in step S15, it is determined that there is no misalignment in the −X direction. Accordingly, the determination results are different. When such different determination results are obtained, in this embodiment, it is determined that there is no misalignment in the X direction. This is similar to the determination of misalignment in the Y direction, and because the occurrence of misalignment and its correction are exceptional cases, if different determination results are obtained, it is unclear whether the misalignment has actually occurred. In such a case, no correction is performed. However, if it is determined that the electrostatic sensor EL or the electrostatic sensor WL is misaligned, correction is performed; alternatively, misalignment may be determined by considering other factors.

In step S13, the misalignment dX in the X direction of the eight electrostatic sensors 110 can be calculated, for example, as follows.

The misalignment dX is a misalignment in the −X direction (W direction) or the +X direction (E direction). The misalignment calculation unit 131 sets a misalignment dX to the value with the smaller absolute value between dAD[WL] and dAD[EL]. This is because, similarly to the case of determining a misalignment dY in the Y direction, even if a misalignment occurs, it is considered not to be large, and thus the value with the smaller absolute value is more likely to be correct. In addition, since the occurrence of misalignment and its correction are exceptional cases, this process reduces the impact of correction. Alternatively, the value may be set to a value with a larger absolute value, or may be set to the average of the absolute values.

Note that the misalignment dX is a length, but since the misalignment dX corresponds to the magnitude of dAD[EL] or dAD[WL], dAD[EL] or dAD[WL] is referred to here as the misalignment dY. In this embodiment, the misalignment calculation unit 131 sets dAD[EL] or dAD[WL], each being a value corresponding to a misalignment, as the misalignment dX. However, in practice, the misalignment dX may be calculated from a capacitance value or by using a correspondence table.

### Steps S21 to S26

In steps S21 to S26, it is determined whether a misalignment in the rotation direction about the Z-axis has occurred as illustrated in FIG. 6D.

The misalignment calculation unit 131 determines whether dAD[NL]>TH[RZ] (Step S21).

When the misalignment calculation unit 131 determines that dAD[NL]>TH[RZ] (Step S21: Yes), it determines whether dAD[SL]>TH[RZ] (Step S22).

When the misalignment calculation unit 131 determines that dAD[SL]>TH[RZ] (Step S22: Yes), it determines whether dAD[EL]>TH[RZ] (Step S23).

When the misalignment calculation unit 131 determines that dAD[EL]>TH[RZ] (Step S23: Yes), it determines whether dAD[WL]>TH[RZ] (Step S24).

When the misalignment calculation unit 131 determines that dAD[WL]<TH[Z] (Step S24: Yes), it calculates a misalignment dRz in the rotation direction about the Z-axis of the eight electrostatic sensors 110 (Step S25).

As illustrated in FIG. 6D, when the sensor unit 150 is misaligned in the rotation direction about the Z-axis, the electrostatic sensors 110 rotate about the Z-axis. Accordingly, the electrostatic sensors NL, SL, EL, and WL become closer to regions corresponding to the diagonal lines of the metal member 11, that is, regions of the metal member 11 with larger areas, compared with when the electrostatic sensors NL, SL, EL, and WL are at the reference positions. Accordingly, the areas of the metal member 11 that contribute to the capacitance of the electrostatic sensors NL, SL, EL, and WL increase compared with those when the electrostatic sensors NL, SL, EL, and WL are at the reference positions. Accordingly, difference values ΔAD of the respective electrostatic sensors NL, SL, EL, and WL also increase compared with those at the reference positions. Note that, when a misalignment in the rotation direction about the Z-axis is 90 degrees, the area of the metal member 11 that contributes to the capacitance is unchanged compared with that at the reference position and the capacitance value is also unchanged. However, a misalignment in the rotation direction about the Z-axis is less than 90 degrees, and typically, even if there is a misalignment, the misalignment is less than or equal to a few degrees. Accordingly, the electrostatic sensors NL, SL, EL, and WL are located in regions corresponding to the diagonal lines of the metal member 11, that is, regions of the metal member 11 with larger areas, compared with those when the electrostatic sensors NL, SL, EL, and WL are at the reference positions. Accordingly, actual difference values ΔAD of the electrostatic sensors increase compared with the difference values ΔAD at the reference positions. Note that the difference values ΔAD of the electrostatic sensors NL, SL, EL, and WL increase similarly when the sensor unit 150 rotates about the Z-axis.

When the misalignment calculation unit 131 determines No in steps S21, S22, S23, or S24, it determines that the misalignment dRz in the rotation direction about the Z-axis of the eight electrostatic sensors 110 is less than or equal to the predetermined value and the value is negligible, and then determines that the misalignment dRz is 0 (dRz=0) (Step S26).

When the determination in steps S22, S23, or S24 is No, it means that the determination results in the preceding steps are Yes, that is, a misalignment about the Z-axis has occurred, and thus the determination results differ. In such a case, it is unclear whether the misalignment has actually occurred. If such different determination results are obtained, no correction is performed since such an occurrence of misalignment and its correction are exceptional cases. However, when the misalignment of any one or some of the electrostatic sensors NL, SL, EL, and WL is greater than or equal to the corresponding threshold value(s), it may be determined that a misalignment in the rotation direction about the Z-axis has occurred.

Note that, in step S25, the misalignment dRz in the rotation direction about the Z-axis of the eight electrostatic sensors 110 can be calculated, for example, as follows.

The misalignment calculation unit 131 sets a misalignment dRz to the value with the smallest absolute value among dAD[NL], dAD[SL], dAD[EL], and dAD[WL].

This is because, even if a misalignment occurs, it is considered not to be large, and thus the value with the smaller absolute value is more likely to be correct. In addition, since the occurrence of misalignment and its correction are exceptional cases, this process reduces the impact of correction. Alternatively, the value may be set to a value with a larger absolute value, or may be set to the average of the absolute values.

Note that the unit of the misalignment dRz is an angle, but the misalignment dRz is a value that corresponds to the magnitude of dAD[NL], dAD[SL], dAD[EL], or dAD[WL], and thus, the misalignment dRz here is defined as dAD[NL], or dAD[SL], dAD[EL], or dAD[WL].

In this embodiment, the misalignment calculation unit 131 sets dAD[NL], or dAD[SL], dAD[EL], or dAD[WL], each being a value corresponding to a misalignment, as the misalignment dRz. However, in practice, the misalignment dRz may be calculated from a capacitance value or by using a correspondence table.

With the above-described processing, the processing of steps S1 to S26 for determining misalignments dX, dY, and dRz in the X direction, in the Y direction, and about the Z-axis respectively is complete (END).

### Steps S31 to S55

Next, a method of determining misalignments dRx, dRy, and dZ about the X-axis and Y-axis, and in Z-axis direction as in FIG. 7 respectively is described with reference to FIG. 8B.

FIG. 8B is a flowchart illustrating an example of processing to be performed by the misalignment calculation unit 131 when any of the misalignments illustrated in FIG. 7 is assumed. Note that when the sensor unit 150 is attached to the metal member 11, and when an attachment mechanism that causes only predetermined misalignment, such as misalignment about the X-axis, is used, it is possible to calculate only misalignment about the X-axis illustrated in steps S31 to S35.

### Steps S31 to S35

In steps S31 to S35, it is determined whether there is a misalignment dRx about the X-axis as illustrated in FIG. 7B.

First, the misalignment calculation unit 131, in response to the start of the processing (Start), determines whether dAD[NL]>0 and dAD[SL]<0, or whether dAD[SL]>0 and dAD[NL]<0 (Step S31).

Determining whether dAD[NL]>0 and dAD[SL]<0 is determining whether the electrostatic sensor NL is misaligned in the −Z direction and is close to the metal member 11, and the electrostatic sensor SL is misaligned in the +Z direction and is away from the metal member 11. The electrostatic sensor NL that is misaligned in the −Z direction and the electrostatic sensor SL that is misaligned in the +Z direction indicate that the eight electrostatic sensors 110 have rotated about the X-axis and are misaligned as illustrated in FIG. 7B.

Determining whether dAD[SL]>0 and dAD[NL]<0 is determining whether the electrostatic sensor SL is misaligned in the −Z direction and is close to the metal member 11, and the electrostatic sensor NL is misaligned in the +Z direction and is away from the metal member 11. The electrostatic sensor SL that is misaligned in the −Z direction, and the electrostatic sensor NL that is misaligned in the +Z direction indicate that the eight electrostatic sensors 110 have rotated about the X-axis in a direction opposite to that illustrated in FIG. 7B and misaligned.

The misalignment calculation unit 131 determines whether dAD[NL]−dAD[SL]>TH[RX] (Step S32). The condition dAD[NL]−dAD[SL]>TH[RX] indicates that, as illustrated in FIG. 7B, when viewed from the −X direction side, the eight electrostatic sensors 110 are rotated about the X-axis in the counterclockwise direction, and that the amount of rotation is equal to or greater than the predetermined value.

When the misalignment calculation unit 131 determines that dAD[NL]−dAD[SL]>TH[RX] (S32: Yes), it calculates a misalignment dRx about the X-axis (Step S33).

When the misalignment calculation unit 131, in step S32, determines that dAD[NL]−dAD[SL]>TH[RX] is not satisfied (S32: No), it determines whether dAD[SL]dAD[NL]>TH[RX] (Step S34). This determination is to determine whether the eight electrostatic sensors 110 have rotated about the X-axis in the clockwise direction by an amount greater than or equal to a predetermined value, as viewed from the +X direction side.

When the misalignment calculation unit 131 determines that dAD[SL]−dAD[NL]>TH[RX] (S34: Yes), it advances the flow to step S33, and calculates a misalignment dRx about the X-axis (Step S33).

When the misalignment calculation unit 131 determines, in step S31, that dAD[NL]>0 and dAD[SL]<0 are not satisfied, and simultaneously that dAD[SL]>0 and dAD[NL]<0 are not satisfied (S31: No), or when, in step S34, it determines that dAD[SL]dAD[NL]>TH[RX] is not satisfied (S34: No), it determines that the misalignment dRx about the X-axis of the eight electrostatic sensors 110 is 0 (dRx=0) (Step S35). In step S35, it is considered that dRx is 0 (dRx=0), or considered that there is a misalignment about the X-axis but it is negligible, and dRx is 0 (dRx=0).

The misalignment calculation unit 131 calculates a misalignment dRx about the X-axis as follows.

The misalignment dRx is a misalignment about the X-axis in the clockwise direction or counterclockwise direction. The misalignment calculation unit 131 sets the value of dAD[NL]−dAD[SL] when Yes in step S32, and sets the value of dAD[SL]−dAD[NL] when Yes in step S34.

Note that the misalignment dRx is an angle, but the misalignment dRx is a value that corresponds to the magnitude of dAD[NL]−dAD[SL], or dAD[SL]−dAD[NL], and thus, the misalignment dRx here is defined as dAD[NL]−dAD[SL] or dAD[SL]−dAD[NL].

In this embodiment, the misalignment calculation unit 131 sets dAD[NL]−dAD[SL], or dAD[SL]−dAD[NL], each being a value corresponding to a misalignment, as the misalignment dRx. However, in practice, the misalignment dRx may be calculated from a capacitance value or by using a correspondence table.

### Steps S41 to S45

Steps S41 to S45 are for determining a misalignment dRy about the Y-axis as illustrated in FIG. 7C, and are essentially equivalent to steps S31 to S35 for determining a misalignment dRx about the X-axis.

The misalignment calculation unit 131 determines whether dAD[WL]>0 and dAD[EL]<0, or whether dAD[EL]>0 and dAD[WL]<0 (Step S41).

Determining whether dAD[WL]>0 and dAD[EL]<0 is determining whether the electrostatic sensor WL is misaligned in the −Z direction and is close to the metal member 11, and the electrostatic sensor EL is misaligned in the +Z direction and is away from the metal member 11. The electrostatic sensor WL that is misaligned in the −Z direction and the electrostatic sensor EL that is misaligned in the +Z direction indicate that the eight electrostatic sensors 110 have rotated about the Y-axis and are misaligned, as illustrated in FIG. 7C.

Determining whether dAD[EL]>0 and dAD[WL]<0 is determining whether the electrostatic sensor EL is misaligned in the −Z direction and is close to the metal member 11, and the electrostatic sensor WL is misaligned in the +Z direction and is away from the metal member 11. The electrostatic sensor EL that is misaligned in the −Z direction, and the electrostatic sensor WL that is misaligned in the +Z direction indicate that the eight electrostatic sensors 110 have rotated about the Y-axis in a direction opposite to that illustrated in FIG. 7B and misaligned.

The misalignment calculation unit 131 determines whether dAD[WL]−dAD[EL]>TH[RY] (Step S42). The condition dAD[WL]−dAD[EL]>TH[RY] indicates that, as illustrated in FIG. 7C, when viewed from the −Y direction side, the eight electrostatic sensors 110 are rotated about the Y-axis in the counterclockwise direction, and that the amount of rotation is equal to or greater than the predetermined value.

When the misalignment calculation unit 131 determines that dAD[WL]−dAD[EL]>TH[RY] (S42: Yes), it calculates a misalignment dRy about the Y-axis (Step S43).

When the misalignment calculation unit 131, in step S42, determines that dAD[WL]−dAD[EL]>TH[RY] is not satisfied (S42: No), it determines whether dAD[EL]−dAD[WL]>TH[RY] (Step S44). This determination is to determine whether the eight electrostatic sensors 110 have rotated about the Y-axis in the clockwise direction by an amount greater than or equal to a predetermined value, as viewed from the −Y direction side.

When the misalignment calculation unit 131 determines that dAD[EL]−dAD[WL]>TH[RY] (S44: Yes), it advances the flow to step S43, and calculates a misalignment dRy about the Y-axis (Step S43).

When the misalignment calculation unit 131 determines, in step S41, that dAD[WL]>0 and dAD[EL]<0 are not satisfied, and simultaneously that dAD[EL]>0 and dAD[WL]<0 are not satisfied (S41: No), or when, in step S44, it determines that dAD[EL]−dAD[WL]>TH[RY] is not satisfied (S44: No), it determines that the misalignment dRy about the Y-axis of the eight electrostatic sensors 110 is 0 (dRy=0) (Step S45). In step S45, it is considered that dRy is 0 (dRy=0), or considered that there is a misalignment about the Y-axis but it is negligible and dRy is 0 (dRy=0).

The misalignment calculation unit 131 calculates a misalignment dRy about the Y-axis as follows.

The misalignment dRy is a misalignment about the Y-axis in the clockwise direction or counterclockwise direction. The misalignment calculation unit 131 sets the value of dAD[WL]−dAD[EL] when Yes in step S42, and sets the value of dAD[EL]−dAD[WL] when Yes in step S44.

Note that the misalignment dRy is an angle, but the misalignment dRy is a value that corresponds to the magnitude of dAD[WL]−dAD[EL], or dAD[EL]−dAD[WL], and thus, the misalignment dRy here is defined as dAD[WL]−dAD[EL] or dAD[EL]−dAD[WL].

In this embodiment, the misalignment calculation unit 131 sets dAD[WL]−dAD[EL], or dAD[EL]−dAD[WL], each being a value corresponding to a misalignment, as the misalignment dRy. However, in practice, the misalignment dRy may be calculated from a capacitance value or by using a correspondence table.

### Steps S51 to S56

In steps S51 to S56, it is determined whether there is a misalignment dZ in the Z-axis direction as illustrated in FIG. 7D.

The misalignment calculation unit 131 determines whether dAD[NL]<-TH[Z] (Step S51).

When the misalignment calculation unit 131 determines that dAD[NL]<TH[Z] (Step S51: Yes), it determines whether dAD[SL]<TH[Z] (Step S52).

When the misalignment calculation unit 131 determines that dAD[SL]<TH[Z] (Step S52: Yes), it determines whether dAD[EL]<TH[Z] (Step S53).

When the misalignment calculation unit 131 determines that dAD[EL]<TH[Z] (Step S53: Yes), it determines whether dAD[WL]<TH[Z] (Step S54).

When the misalignment calculation unit 131 determines that dAD[WL]<TH[Z] (Step S54: Yes), it calculates a misalignment dZ in the Z direction of the eight electrostatic sensors 110 (Step S55).

As illustrated in FIG. 7D, when the sensor unit 150 is misaligned in the +Z direction, the electrostatic sensors 110 are displaced in the +Z direction. Accordingly, the electrostatic sensors NL, SL, EL, and WL are positioned farther from the metal member 11 than when they are at the reference positions respectively. Accordingly, the difference values ΔAD of the respective electrostatic sensors NL, SL, EL, and WL decrease compared with those at the reference positions. When the difference values are smaller than the threshold TH[Z] (negative value), that is, when the difference values have decreased by the predetermined amount or more, it is determined that a misalignment has occurred. Note that the difference values ΔAD of the electrostatic sensors NL, SL, EL, and WL similarly decrease when the sensor unit 150 is misaligned in the +Z direction.

When the misalignment calculation unit 131 determines No in steps S51, S52, S53, or S54, it determines that the misalignment dZ in the Z direction of the eight electrostatic sensors 110 is less than or equal to the predetermined value and the value is negligible, and then determines that the misalignment dZ is 0 (dZ=0) (Step S56).

When the determination in steps S52, S53, or S54 is No, it means that the determination results in the preceding steps are Yes, that is, a misalignment in the Z direction has occurred. In such a case, it is unclear whether the misalignment has actually occurred. If such different determination results are obtained, no correction is performed since such an occurrence of misalignment and its correction are exceptional cases. However, when the misalignment of any one or some of the electrostatic sensors NL, SL, EL, and WL is greater than or equal to the corresponding threshold value(s), it may be determined that a misalignment in the Z direction has occurred.

In step S55, the misalignment dZ in the Z direction of the eight electrostatic sensors 110 can be calculated, for example, as follows.

The misalignment calculation unit 131 sets a misalignment dZ to the value with the smallest absolute value among dAD[NL], dAD[SL], dAD[EL], and dAD[WL].

This is because, even if a misalignment occurs, it is considered not to be large, and thus the value with the smaller absolute value is more likely to be correct. In addition, since the occurrence of misalignment and its correction are exceptional cases, this process reduces the impact of correction. Alternatively, the value may be set to a value with a largest absolute value, or may be set to the average of the absolute values.

Note that the unit of the misalignment dZ is a distance, but the misalignment dZ is a value that corresponds to the magnitude of dAD[NL], dAD[SL], dAD[EL], or dAD[WL], and thus, the misalignment dZ here is defined as dAD[NL], or dAD[SL], dAD[EL], or dAD[WL].

In this embodiment, the misalignment calculation unit 131 sets dAD[NL], or dAD[SL], dAD[EL], or dAD[WL], each being a value corresponding to a misalignment, as the misalignment dZ. However, in practice, the misalignment dZ may be calculated from a capacitance value or by using a correspondence table.

With the above-described processing, the processing of steps S31 to S56 for determining misalignments dRx, dRy, and dZ about the X-axis and Y-axis, and in the Z-axis direction respectively is complete (END).

### Calculation of Correction Value

Next, calculation of correction values performed in the correction value calculation unit 132 and calculation of a correction coefficient for calculating correction values will be described. The correction coefficient is a coefficient determined to correct a misalignment for a difference value ΔAD measured at each electrode under actual operating conditions. Specifically, the correction value is a value determined by correcting a difference value ΔAD under actual operating conditions in accordance with a misalignment, and represents a predicted value that would be measured if the sensor unit 150 were disposed at the reference position. In this embodiment, a correction value is determined by multiplying an actually measured difference value ΔAD under operating conditions by a correction coefficient. A threshold value for determining touch or proximity to any of the operation portions 210A is set based on a difference value ΔAD when the sensor unit 150 is attached at the reference position. Accordingly, by determining a correction value of a difference value ΔAD that corresponds to an actually measured value, more accurate determination can be achieved.

First, a method of determining a correction value when a misalignment illustrated in FIG. 6 has occurred is described. This process is performed after the operation shown in the flowchart in FIG. 8A.

In step S3, a misalignment dY is set to the value with the smaller absolute value between dAD[SL] and dAD[NL]. When the absolute value of dAD[SL] is smaller, a correction coefficient k1 is determined as follows.

k1=(difference value ΔAD[SL] at the reference position)/(actual difference value ΔAD[SL])

Specifically, the correction coefficient k is determined based on the capacitance value of the electrode that corresponds to the value with the smaller absolute value between dAD[SL] and dAD[NL]. The denominator is the difference value ΔAD of the electrode measured after the sensor unit 150 is actually attached to the metal member 11, in a state in which no detection target object such as a fingertip is present in the vicinity, and the numerator is the difference value ΔAD of the electrode measured when the sensor unit 150 is attached to the metal member 11 at the reference position with no misalignment, in a state in which no detection target object such as a fingertip is present in the vicinity.

The correction coefficient k1 is stored in the memory, and when a detection target such as a fingertip is in the proximity of the electrodes during actual use, a difference value ΔAD is determined from an actual digital value AD of the electrode SL, and a correction value of the electrode SL is determined by multiplying the value by the correction coefficient k1.

For the electrode NL, a difference value ΔAD is determined from an actual digital value AD, and a correction value of the electrode NL is determined by multiplying the value by a correction coefficient 1/(k1). As mentioned earlier, when the electrostatic sensors are misaligned in the Y direction, the difference value ΔAD of one of the opposing electrodes increases and that of the other one decreases relative to those at the respective reference positions. Accordingly, the actual digital values AD of the electrode SL and electrode NL are measured as approximately k1 times the value at the reference position of one electrode and approximately 1/(k1) times the value at the reference position of the other electrode. Accordingly, by correcting the respective values by multiplying the values by 1/(k) or k1, difference values ΔAD to be measured in a state in which the sensor unit 150 is attached to the metal member 11 at the respective reference positions can be estimated.

Note that when dAD[NL] is smaller between dAD[SL] and dAD[NL], the same applies, and a correction coefficient k2 is determined as follows.

k2=(difference value ΔAD[NL] at the reference position)/(actual difference value ΔAD[NL])

The correction coefficient k2 is stored in the memory, and when a detection target such as a fingertip is in the proximity of the electrodes during actual use, a difference value ΔAD is determined from an actual digital value AD of the electrode NL, and a correction value of the electrode NL is determined by multiplying the value by the correction coefficient k2. When dAD[NL] is smaller than dAD[SL], for the electrode SL, the process is the same as described for the case in which dAD[SL] is smaller than dAD[NL], and a difference value ΔAD is determined from an actual digital value AD, and a correction value of the electrode SL is determined by multiplying the value by a correction coefficient 1/(k2).

In the above embodiment, the equation for determining the correction coefficient is changed depending on whether dAD[SL] or dAD[NL] is smaller. However, without the change, a correction coefficient k3 for the electrode SL may be determined by k3=(difference value ΔAD[SL] at the reference position)/(actual difference value ΔAD[SL]), and a correction coefficient k4 for the electrode NL may be determined by k4=(difference value ΔAD[NL] at the reference position)/(actual difference value ΔAD[NL]), and then respective correction values may be calculated.

In step S6, when it is determined that dY=0, the correction coefficient k is set to 1 and no correction is performed.

A method of determining correction coefficients k and correction values after step S13 is the same as the method of calculating the correction coefficients after step S3 described above. In step 13, when dAD[WL] is smaller between dAD[WL] and dAD[EL], a correction coefficient k5 is determined as follows:

k5=(difference value ΔAD[WL] at the reference position)/(actual difference value ΔAD[WL]).

The correction coefficient k5 is stored in the memory, and when a detection target such as a fingertip is in the proximity of the electrodes during actual use, a difference value ΔAD is determined from an actual digital value AD of the electrode WL, and a correction value of the electrode WL is determined by multiplying the value by the correction coefficient K5. For the electrode EL, a difference value ΔAD is determined from an actual digital value AD, and a correction value of the electrode EL is determined by multiplying the value by a correction coefficient 1/(k5).

When dAD[EL] is smaller between dAD[WL] and dAD[EL], a correction coefficient k6 is determined as follows:

k6=(difference value ΔAD[EL] at the reference position)/(actual difference value ΔAD[EL]).

The correction coefficient k6 is stored in the memory, and when a detection target such as a fingertip is in the proximity of the electrodes during actual use, a difference value ΔAD is determined from an actual digital value AD of the electrode EL, and a correction value of the electrode EL is determined by multiplying the value by the correction coefficient k6. For the electrode WL, a difference value ΔAD is determined from an actual digital value AD, and a correction value of the electrode WL is determined by multiplying the value by a correction coefficient 1/(k6).

In the above embodiment, the equations for determining the correction coefficients are changed depending on whether dAD[WL] or dAD[EL] is smaller. However, without the change, a correction coefficient k7 for the electrode WL may be determined by k7=(difference value ΔAD[WL] at the reference position)/(actual difference value ΔAD[WL]), and a correction coefficient k8 for the electrode EL may be determined by k8=(difference value ΔAD[EL] at the reference position)/(actual difference value ΔAD[EL]), and then respective correction values may be calculated.

In step S16, when it is determined that dX=0, the correction coefficient k is set to 1 and no correction is performed.

In step S25, the misalignment dRz is set to the value with the smallest absolute value among dAD[NL], dAD[SL], dAD[EL], and dAD[WL]. A correction coefficient k9 is calculated for the electrode that corresponds to this value, and correction values of the other electrodes are also corrected by using the correction coefficient k9. For example, when dAD[NL] is smallest, the correction coefficient k9 is determined by k9=(difference value ΔAD[NL] at the reference position)/(actual difference value ΔAD[NL]). The correction coefficients k for the electrodes SL, EL, and WL are also set to the same correction coefficient k9.

In the above embodiment, the correction coefficient is determined for the electrode that corresponds to the value with the smallest absolute value among dAD[NL], dAD[SL], dAD[EL], and dAD[WL]. However, correction coefficients may be determined for the respective electrodes by using a similar equation, and correction values may be determined.

In step S26, when it is determined that dRz=0, the correction coefficient k is set to 1 and no correction is performed.

In the above description, the method of determining correction values of the lower electrodes NL, SL, EL, and WL has been described. For correction values of the upper electrodes NU, SU, EU, and WU, the correction coefficients k determined for the lower electrodes NL, SL, EL, and WL are used respectively as correction coefficients k for the corresponding upper electrodes. The correction coefficients k are determined for the lower electrodes because these electrodes are closer to the metal member 11. This results in values ΔAD and values dAD with large absolute values, enabling more precise determination of misalignment. Correction values of the upper electrodes NU, SU, EU, and WU may also be determined by using a method similar to that used for the lower electrodes NL, SL, EL, and WL.

Next, a method of determining correction values to be performed by the correction value calculation unit 132 when the sensor unit 150 is misaligned relative to the metal member 11 as illustrated in FIG. 7 will be described. This process is performed after the operation shown in the flowchart in FIG. 8B. In step S33, a misalignment dRx is set to dAD[NL]−dAD[SL], or dAD[SL]−dAD[NL]. A correction coefficient k10 for the electrode NL is determined by k10=(difference value ΔAD[NL] at the reference position)/(actual difference value ΔAD[NL]). A correction coefficient k11 for the electrode SL is determined by k11=(difference value ΔAD[SL] at the reference position)/(actual difference value ΔAD[SL]).

In this case, dAD[SL] and dAD[NL] in the rotation-angle misalignment dAD[NL]−dAD[SL], or dAD[SL]−dAD[NL] are both values that correspond to angles, and the correction coefficients k10 and k11 are also values that correspond to the misalignment dRx.

The correction coefficients k10 and k11 are stored in the memory, and when a detection target such as a fingertip is in the proximity of the electrodes during actual use, a difference value ΔAD is determined from an actual digital value AD of the electrode NL or the electrode SL, and a correction value of the electrode NL or the electrode SL is determined by multiplying the value by the correction coefficient k10 or k11.

In step S33, dRx is set to the value with the smaller absolute value between AD[NL] and dAD[SL], and similarly to the method of determining a correction value performed after step 3, difference values ΔAD of the respective electrodes may be multiplied respectively by a correction coefficient k12 for an electrode with the smaller absolute value between dAD[SL] and dAD[NL] and a correction coefficient 1/(k12) to determine respective correction values.

In step S35, when it is determined that dRx =0, the correction coefficient k is set to 1 and no correction is performed.

A method of determining a correction value after setting the misalignment dRy to dAD[WL]−dAD[EL] or dAD[EL]−dAD[WL] in step S43 is the same as the method of determining the correction value performed after dRx is set in the aforementioned step 33.

A correction coefficient k for the electrode WL is determined by k13=(difference value ΔAD[WL] at the reference position)/(actual difference value ΔAD[WL]). A correction coefficient k for the electrode EL is determined by k14=(difference value ΔAD[EL] at the reference position)/(actual difference value ΔAD[EL]).

Similarly, both correction coefficients k13 and k14 are values that correspond to dRy.

The correction coefficients k13 and k14 are stored in the memory, and when a detection target such as a fingertip is in the proximity of the electrodes during actual use, a difference value ΔAD is determined from an actual digital value AD of the electrode WL or the electrode EL, and a correction value of the electrode WL or the electrode EL is determined by multiplying the value by the correction coefficient K13 or k14.

In step S43, dRy is set to the value with the smaller absolute value between AD[WL] and dAD[EL], and similarly to the method of determining a correction value performed after step 13, difference values ΔAD of the respective electrodes may be multiplied respectively by a correction coefficient k15 for the electrode with the smaller absolute value between dAD[WL] and dAD[EL] and a correction coefficient 1/(k15) to determine respective correction values.

In step S45, when it is determined that dRy=0, the correction coefficient k is set to 1 and no correction is performed.

In step S55, the misalignment dZ is set to the value with the smallest absolute value among dAD[NL], dAD[SL], dAD[EL], and dAD[WL]. A correction coefficient k16 is calculated for the electrode that corresponds to this value, and correction values of the other electrodes are also corrected by using the correction coefficient k16. For example, when dAD[NL] is smallest, the correction coefficient k16 is determined by k16=(difference value ΔAD[NL] at the reference position)/(actual difference value ΔAD[NL]). The correction coefficients k for electrodes SL, EL, and WL are also set to the same corrected value k16.

In the above embodiment, the correction coefficient k16 is determined for the electrode that corresponds to the value with the smallest absolute value among dAD[NL], dAD[SL], dAD[EL], and dAD[WL]. However, correction coefficients k may be determined for the respective electrodes by using a similar equation.

In step S56, when it is determined that dZ=0, the correction coefficient k is set to 1 and no correction is performed.

In the above description, the method of determining correction values of the lower electrodes NL, SL, EL, and WL has been described. As in the cases illustrated in FIG. 6 in which the sensor unit 150 is misaligned, for correction values of the upper electrodes NU, SU, EU, and WU, the correction coefficients k determined for the lower electrodes NL, SL, EL, and WL are used respectively as correction coefficients k for the corresponding upper electrodes. The correction coefficients are determined for the lower electrodes because these electrodes are closer to the metal member 11. This results in values ΔAD and values dAD with large absolute values, enabling more precise determination of misalignment. Correction values of the upper electrodes NU, SU, EU, and WU may also be determined by using a method similar to that used for the lower electrodes NL, SL, EL, and WL.

Note that, as a modification, correction coefficients k may be determined for all electrostatic sensors respectively, and difference values ΔAD of the respective electrostatic sensors may be corrected. Specifically, correction coefficients k that correspond to respective electrodes are determined from ΔAD values at the reference positions of the respective electrostatic sensors and actual difference values (difference values ΔAD measured after the electrostatic sensors are attached to the metal member 11, in a state in which no detection target object is present in the vicinity), and difference values ΔAD measured under actual operating conditions are corrected for respective electrodes. The correction coefficients are similar to those described above, and each is expressed as (difference value ΔAD at the reference position)/(actual difference value ΔAD), representing values corresponding to misalignments.

In such a case, when the substrate and the sensor unit 150 are misaligned and both a misalignment illustrated in FIG. 6 and a misalignment illustrated in FIG. 7 have occurred, such misalignments can be accommodated.

### Detection of Position of Target Object by Detection Unit 133 (Detection of Which Operation Portion 210A Is Being Touched

The detection unit 133 detects a position of a target object relative to the operation portion 210A based on an output of the detection circuit 120 and a plurality of correction values calculated by the correction value calculation unit 132. As an example, a case in which a target object such as a fingertip is in proximity to or touching a north-side operation portion 210AN of the operation portions 210A in FIG. 1 will be described. When a target object such as a fingertip is in proximity to or touching the operation portion 210AN, the difference value ΔAD of the electrode NU becomes greater than or equal to a predetermined threshold value. In addition, the difference value ΔAD of the upper electrode NU becomes larger than the difference value ΔAD of the lower electrode NL by a predetermined amount or more. In addition, the difference values ΔAD of the electrodes WU and EU are equivalent within a predetermined range, and the difference value ΔAD of the electrode NU is the largest, followed by the difference values ΔAD of the electrodes WU and EU, and finally the difference value ΔAD of the electrode SU is the smallest. Accordingly, as a method of detecting whether a target object is touching any of the operation portions 210A to be performed by the detection unit 133 includes, identifying an upper electrode with a value greater than or equal to a predetermined threshold value, and when a difference value ΔAD of an electrode that is on the lower side of the upper electrode is smaller than that of the upper electrode by a predetermined value or more, each of difference values ΔAD of upper electrodes that are on both sides of the identified electrode is smaller than the difference value ΔAD of the identified electrode and is within a predetermined range, and a difference value ΔAD of an upper electrode that faces the identified electrode is the smallest, determining that the target object is touching or in proximity to the operation portion 210A that is closest to the identified electrode. Note that determining proximity or touch of a target object is equivalent to detecting whether the object is located within a predetermined range or at a predetermined position, and is included within the concept of position detection.

Then, the ECU 130 of the operation unit determines that the specific operation portion 210A has been operated and outputs a signal indicating such an operation to the outside.

### Advantages

The detection device 100 includes the electrostatic sensor 110 disposed on the base plate 10 having the metal member 11 to which a predetermined potential or a potential of a predetermined waveform is applied, the detection circuit 120 connected to the electrostatic sensor 110 and configured to detect a capacitance of the electrostatic sensor 110, the misalignment calculation unit 131 configured to calculate a misalignment of the electrostatic sensor 110 relative to the metal member 11 or a value corresponding to the misalignment, based on an output of the detection circuit 120 in a non-proximity state in which a target object is not in close proximity to the metal member 11, the correction value calculation unit 132 configured to calculate a correction value corresponding to the misalignment calculated by the misalignment calculation unit 131 or to a value corresponding to a misalignment, and the detection unit 133 configured to detect a position of a target object based on the output of the detection circuit 120 and the correction value calculated by the correction value calculation unit 132. By calculating a misalignment of the electrostatic sensor 110 relative to the metal member 11 or a value corresponding to the misalignment, it is possible to determine the position of a target object relative to the metal member 11 while taking into account variations in the parasitic capacitance between the electrostatic sensor 110 and the metal member 11 caused by the misalignment of the electrostatic sensor 110 relative to the metal member 11.

Accordingly, the detection device 100 capable of accurately detecting the position of a target object can be provided.

Note that, as described above, in this embodiment, the correction value is a value determined by correcting a misalignment for a difference value ΔAD measured at each electrode under an actual operating condition, and represents a predicted value of difference value ΔAD that would be measured if the sensor unit 150 were disposed at the reference position. However, when a difference value ΔAD measured under an actual operating condition exceeds a threshold value, and for example, when a determination of whether the distance from a target object to the metal member 11 is within a predetermined value and the target object is in the proximity to the metal member 11 is performed, the threshold value may be corrected and the determination may be performed.

In addition, in this embodiment, to determine the position of a target object relative to the metal member 11, which one of the operation portions 210A has received a proximity or touch operation is determined; however, an absolute position of the target object may be determined.

The electrostatic sensor 110 may include a plurality of electrostatic sensors 110, the detection circuit 120 may be connected to the plurality of electrostatic sensors 110 and may be configured to detect a capacitance of each electrostatic sensor 110, the misalignment calculation unit 131 may calculate misalignments of the plurality of electrostatic sensors 110 relative to the metal member 11 based on the output of the detection circuit 120 in the target object non-proximity state, the correction value calculation unit 132 may calculate a plurality of correction values that correspond to misalignments of the plurality of electrostatic sensors 110 calculated by the misalignment calculation unit 131 or correspond to a plurality of values corresponding to the misalignments respectively, and the detection unit 133 may detect a position of the target object relative to the metal member 11 based on the output of the detection circuit 120 and the plurality of correction values calculated by the correction value calculation unit 132. By calculating misalignments of a plurality of electrostatic sensors 110 relative to the metal member 11, it is possible to determine the position of the target object relative to the metal member 11 while taking into account variations in the parasitic capacitance between the plurality of electrostatic sensor 110 and the metal member 11. Accordingly, in the structure in which a plurality of electrostatic sensors 110 are provided, the detection device 100 capable of accurately detecting the position of a target object relative to the metal member 11 can be provided. In addition, since the position of a target object can be determined based on the outputs of the plurality of electrostatic sensors 110, the structure in which the electrostatic sensor 110 is not disposed directly under the operation portions 210A can be achieved, thereby increasing the flexibility in the placement of the electrostatic sensors 110.

The plurality of electrostatic sensors 110 may be disposed on the side surface 151a1 of the sensor unit 150 operable by the target object, the plurality of electrostatic sensors 110 may be disposed on the base plate 10 by attaching the sensor unit 150 to the base plate 10, and the sensor unit 150 may determine an operation performed by the target object on the operation portions 210A that are positioned to the base plate 10 based on the position of the target object relative to the metal member 11 detected by the detection unit 133. If the position of the sensor unit 150 relative to the base plate 10 is misaligned and the positions of the plurality of electrostatic sensors 110 relative to the base plate 10 are misaligned, output of the plurality of electrostatic sensors 110 can be corrected according to the misalignment. Accordingly, the detection device 100 capable of correcting output of the plurality of electrostatic sensors 110 according to a misalignment and accurately detecting the position of the target object can be provided.

The sensor unit 150 may extend in a first direction and a second direction mutually perpendicular to each other within a plane in which the metal member 11 extends, the plurality of electrostatic sensors 110 may include first electrostatic sensors 110 located in the first direction and second electrostatic sensors 110 located in the second direction, and an outer edge of the metal member 11 may be located within a range in which the detection circuit 120 is capable of detecting capacitances of the first electrostatic sensors 110 and the second electrostatic sensors 110. When the positional relationship between the metal member 11 and the first electrostatic sensors 110 or the second electrostatic sensors 110 in a plane direction is misaligned, output values of the first electrostatic sensors 110 or the second electrostatic sensors 110 change, and thus the misalignment of the first electrostatic sensors 110 or the second electrostatic sensors 110 relative to the metal member 11 can be detected (step S3 or step S13).

The sensor unit 150 may extend in a first direction and a second direction mutually perpendicular to each other within a plane in which the metal member 11 extends, the side surface may be located on one side and the other side in the first direction, the plurality of electrostatic sensors 110 may be located on the one side and the other side in the first direction, and the misalignment calculation unit 131, based on the output of the detection circuit 120 in the target object non-proximity state, may calculate a difference in capacitance between the electrostatic sensor 110 on the one side and the electrostatic sensor 110 on the other side, and based on the difference, detect a rotational misalignment about a second axis (X-axis or Y-axis) extending in the second direction of the electrostatic sensor 110 on the one side and the electrostatic sensor 110 on the other side relative to the metal member 11. Based on the capacitance relationship between the capacitance of the electrostatic sensor 110 on one side and the capacitance of the electrostatic sensor 110 on the other side, a rotational misalignment about the second axis can be detected (step S33 or step S34).

The sensor unit 150 may extend in a first direction and a second direction mutually perpendicular to each other within a plane in which the metal member 11 extends, the plurality of electrostatic sensors 110 may be located on the one side and the other side in the first direction, and the misalignment calculation unit 131, based on the output of the detection circuit 120 in the target object non-proximity state, when both of a capacitance of the electrostatic sensor 110 on the one side and a capacitance of the electrostatic sensor 110 on the other side are greater than or equal to a predetermined threshold value, may detect a misalignment in a third direction perpendicular to the first direction and the second direction of the electrostatic sensor 110 on the one side and the electrostatic sensor 110 on the other side relative to the metal member 11. Based on outputs of the plurality of electrostatic sensors 110, a misalignment in the Z direction can be calculated (step S55).

The operation panel 210 having the protruding portion 214 having the operation portions 210A in the top surface may be mounted on the base plate 10, and the sensor unit 150 may be disposed in the protruding portion 214. Accordingly, the electrostatic sensors can be readily disposed in the operation panel 210.

Each of the first electrostatic sensors 110 and the second electrostatic sensors 110 may be formed in a planar shape along the side surface 151a1 of the sensor unit 150. Accordingly, detection sensitivity can be increased compared with wire-based configurations.

The plurality of electrostatic sensors 110 may be disposed on the side surface of the sensor unit 150 in a third direction (Z-axis direction) perpendicular to the first direction and the second direction. Accordingly, whether an object is located above the top surface 151a2 of the sensor unit 150 or located facing the side surface 151a1 can be determined.

A correction value may be determined by using lower side electrostatic sensors 110 close to the metal member 11. Accordingly, the value changes largely according to the misalignment and this value can be used, thereby increasing the accuracy.

The temperature sensor 140 that includes a thermistor may be provided to set a baseline of the electrostatic sensor 110, thereby making the sensor less susceptible to the effects of misalignment.

When the operation unit 200 is not operated, the misalignment calculation unit 131 may calculate a value corresponding to the misalignment of the electrostatic sensor 110 relative to the metal member 11 or the value corresponding to the misalignment. Accordingly, even after a vehicle that includes the operation unit is delivered to the user, the correction coefficient can be changed. Therefore, even if misalignment occurs while the user is using the operation unit, it is possible to perform correction in subsequent detection.

While the detection device and the operation unit according to the exemplary embodiment of the disclosure have been described, it is to be understood that the disclosure is not limited to this embodiment disclosed specifically, and various modifications or changes may be made without departing from the scope of the claims.

What is claimed is:

1. A detection device comprising:
an electrostatic sensor disposed on a holding member having a conductor to which a predetermined potential or a potential of a predetermined waveform is applied;
a detection circuit connected to the electrostatic sensor and configured to detect a capacitance of the electrostatic sensor;
a misalignment calculation unit configured to calculate a misalignment of the electrostatic sensor relative to the conductor or a value corresponding to the misalignment, based on an output of the detection circuit in a non-proximity state in which a target object is not in close proximity to the conductor;
a correction value calculation unit configured to calculate a correction value corresponding to the misalignment calculated by the misalignment calculation unit or to the value corresponding to the misalignment; and
a detection unit configured to detect a position of a target object based on the output of the detection circuit and the correction value calculated by the correction value calculation unit.

2. The detection device according to claim 1, wherein
the electrostatic sensor comprises a plurality of electrostatic sensors,
the detection circuit is connected to the plurality of electrostatic sensors and is configured to detect a capacitance of each electrostatic sensor,
the misalignment calculation unit calculates misalignments of the plurality of electrostatic sensors relative to the conductor based on the output of the detection circuit in the target object non-proximity state,
the correction value calculation unit calculates a plurality of correction values that correspond to the misalignments of the plurality of electrostatic sensors calculated by the misalignment calculation unit or correspond to a plurality of values corresponding to the misalignments respectively, and
the detection unit detects a position of the target object relative to the conductor based on the output of the detection circuit and the plurality of correction values calculated by the correction value calculation unit.

3. The detection device according to claim 2, wherein
the plurality of electrostatic sensors are disposed on a side surface of a sensor unit operable by the target object,
the plurality of electrostatic sensors are disposed on the holding member by attaching the sensor unit to the holding member, and
the sensor unit determines an operation performed by the target object based on the position of the target object relative to the conductor detected by the detection unit.

4. The detection device according to claim 3, wherein
the sensor unit extends in a first direction and a second direction mutually perpendicular to each other within a plane in which the conductor extends,
the plurality of electrostatic sensors include first electrostatic sensors located in the first direction and second electrostatic sensors located in the second direction, and
an outer edge of the conductor is located within a range in which the detection circuit is capable of detecting capacitances of the first electrostatic sensors and the second electrostatic sensors.

5. The detection device according to claim 3, wherein
the sensor unit extends in a first direction and a second direction mutually perpendicular to each other within a plane in which the conductor extends,
the side surface is located on one side and the other side in the first direction,
the plurality of electrostatic sensors are located on the one side and the other side in the first direction, and
the misalignment calculation unit, based on the output of the detection circuit in the target object non-proximity state, calculates a difference in capacitance between the electrostatic sensor on the one side and the electrostatic sensor on the other side, and based on the difference, detects a rotational misalignment about a second axis extending in the second direction of the electrostatic sensor on the one side and the electrostatic sensor on the other side relative to the conductor.

6. The detection device according to claim 3, wherein
the sensor unit extends in a first direction and a second direction mutually perpendicular to each other within a plane in which the conductor extends,
the side surface is located on one side and the other side in the first direction,
the plurality of electrostatic sensors are located on the one side and the other side in the first direction, and
the misalignment calculation unit, based on the output of the detection circuit in the target object non-proximity state, when both of a capacitance of the electrostatic sensor on the one side and a capacitance of the electrostatic sensor on the other side are greater than or equal to a predetermined threshold value, detects a misalignment in a third direction perpendicular to the first direction and the second direction of the electrostatic sensor on the one side and the electrostatic sensor on the other side relative to the conductor.

7. The detection device according to claim 3, wherein an operation panel having a protruding portion having an operation portion in a top surface is mounted on the holding member, and the sensor unit is disposed in the protruding portion.

8. The detection device according to claim 4, wherein each of the first electrostatic sensors and the second electrostatic sensors is formed in a planar shape along the side surface of the sensor unit.

9. The detection device according to claim 4, wherein the plurality of electrostatic sensors are disposed on the side surface of the sensor unit in a third direction perpendicular to the first direction and the second direction.

10. The detection device according to claim 9, wherein the correction value calculation unit calculates the correction values by using the electrostatic sensors close to the conductor.

11. The detection device according to claim 1, further comprising:
a thermistor to set a baseline of the electrostatic sensor.

12. An operation unit comprising:
the detection device according to claim 1, wherein when the operation unit is not operated, the misalignment calculation unit calculates the misalignment of the electrostatic sensor relative to the conductor or the value corresponding to the misalignment.
